(19) United States
(12) Patent Application Publication
(10) Pub. No.: US 2024/0145738 A1
(43) Pub. Date: May 2, 2024

(54) FUEL CELL COMPOSITE MEMBER AND MANUFACTURING METHOD THEREFOR

(71) Applicant: Sumitomo Riko Company Limited, Aichi (JP)

(72) Inventors: Masahiro Onishi, Aichi (JP); Takahiro Shinozaki, Aichi (JP); Shota Sakai, Aichi (JP)

(73) Assignee: Sumitomo Riko Company Limited, Aichi (JP)

(21) Appl. No.: 18/462,417

(22) Filed: Sep. 7, 2023

(30) Foreign Application Priority Data
Oct. 26, 2022 (JP) 2022-171803

(51) Int. Cl. H01M 8/0276; H01M 8/0286; H01M 8/1004

(52) U.S. Cl. CPC H01M 8/0276; H01M 8/0286; H01M 8/1004

(57) ABSTRACT

A fuel cell composite member 1 includes a plate-like member 2 having a gasket disposition part 4 having a front-side disposition part 4U disposed on a front surface 2U and a rear-side disposition part 4D disposed on a rear surface 2D and a gasket 5 integrally molded with the gasket disposition part 4. The front-side disposition part 4U has a continuous part 40U disposed around desired sealing target regions 22ULa, 22ULc, 22URa, 22URc, and 22UM and an independent part 41U independent from the continuous part 40U and disposed on the outer side of the continuous part 40U in a surface direction. The continuous part 40U and the independent part 41U communicate with each other through continuous part inner penetrating holes 402Ua, the rear-side disposition part 4D, and independent part inner penetrating holes 410U. In the independent part 41U, the gasket 5 does not protrude forward from the front surface 2U.

### CROSS-REFERENCE TO RELATED APPLICATION

This application claims the priority benefit of Japan application serial No. 2022-171803, filed on October 26, 2022. The entirety of the above-mentioned patent application is hereby incorporated by reference herein and made a part of this specification.

### BACKGROUND

### Technical Field

The disclosure relates to a fuel cell composite member including a gasket integrally molded with a plate-like member and a manufacturing method therefor.

### Description of Related Art

A gasket is disposed around a sealing target region (a manifold, a membrane electrode assembly, or the like) of a separator of a fuel cell. As a method for disposing a gasket in a separator, an exemplary example is a method in which a separate gasket produced in advance is attached to the separator. In the case of this method, work of mounting a thin and flexible gasket in a gasket disposition part of a separator is required. In addition, work of applying an adhesive to the gasket disposition part of the separator before the mounting of the gasket is required. This work is cumbersome.

Regarding this point, Patent Document 1 discloses a method in which a gasket is integrally molded with a separator. In the case of this method, the separator and the gasket can be integrated while performing the injection molding of the gasket by injecting the raw material of the gasket into the cavity of a mold in which the separator is disposed. Therefore, the above-described gasket disposition work or adhesive application work is not required.

### Patent Documents

[Patent Document 1] Japanese Patent Laid-Open No. 2011-96545

However, in the case of the method of the same document, there is a concern that the shape accuracy of the gasket may deteriorate due to a molding defect in the gasket. Therefore, there is a concern that sealing properties with respect to a sealing target region may deteriorate. Therefore, the disclosure provides a fuel cell composite member capable of suppressing the deterioration of sealing properties and a manufacturing method therefor.

### SUMMARY

According to an aspect of the disclosure, a fuel cell composite member includes: a plate-like member having a gasket disposition part; and a gasket that is integrally molded with the gasket disposition part. The gasket disposition part has a front-side disposition part that is disposed on a front surface of the plate-like member and a rear-side disposition part that is disposed on a rear surface of the plate-like member. The front-side disposition part has a continuous part that is provided to be recessed on the front surface and disposed around a desired sealing target region and an independent part that is provided to be recessed on the front surface, independent from the continuous part, and disposed on an outer side of the continuous part in a surface direction. The continuous part has a continuous part inner penetrating hole that penetrates the plate-like member in a front and rear direction and continues to the rear-side disposition part, the independent part has an independent part inner penetrating hole that penetrates the plate-like member in the front and rear direction and continues to the rear-side disposition part The continuous part and the independent part communicate with each other through the continuous part inner penetrating hole, the rear-side disposition part, and the independent part inner penetrating hole. In the independent part, the gasket is disposed so as not to protrude forward from the front surface.

### BRIEF DESCRIPTION OF THE DRAWINGS

FIG. 1 is a perspective view of a stack of fuel cells including a fuel cell composite member of a first embodiment.

FIG. 2 is an exploded perspective view of a part II in FIG. 1.

FIG. 3 is an exploded perspective view of a part III in FIG. 1.

FIG. 4 is a top view of the fuel cell composite member of the first embodiment.

FIG. 5 is a top view of a first separator of the same fuel cell composite member.

FIG. 6 is a bottom view of the same fuel cell composite member.

FIG. 7 is a bottom view of the first separator of the same fuel cell composite member.

FIG. 8 is an enlarged view of the inside of a frame VIII in FIG. 4.

FIG. 9 is a cross-sectional view in an IX-IX direction of FIG. 8.

FIG. 10 is an enlarged view of the inside of a circle X in FIG. 8.

FIG. 11 is a cross-sectional view in an XI-XI direction of FIG. 10.

FIG. 12 is an enlarged view of the inside of a frame XII in FIG. 8.

FIG. 13 is a cross-sectional view in an XIII-XIII direction of FIG. 12.

FIG. 14 is an enlarged view of the inside of a frame XIV in FIG. 8.

FIG. 15 is an enlarged view of the inside of a frame XV in FIG. 14.

FIG. 16 is a cross-sectional view in an XVI-XVI direction of FIG. 15.

FIG. 17 is an enlarged view of the inside of a frame XVII in FIG. 6.

FIG. 18 is a top view of a second separator of the first embodiment.

FIG. 19 is a bottom view of the same second separator.

FIG. 20 is a vertical-direction partial cross-sectional view of the stack shown in FIG. 1.

FIG. 21 is a schematic view of a first stage of a disposition step of a method for manufacturing a fuel cell composite member of the first embodiment.

FIG. 22 is a schematic view of a second stage of the same step.

FIG. 23 is a schematic view of the same stage.

FIG. 24 is a schematic view of a raw material injection step of the same manufacturing method.

FIG. 25 shows a vertical-direction partial cross-sectional view of a stack of fuel cells including a fuel cell composite member of a second embodiment.

### DESCRIPTION OF THE EMBODIMENTS

(1) A fuel cell composite member of the disclosure is a fuel cell composite member including a plate-like member having a gasket disposition part and a gasket that is integrally molded with the gasket disposition part, in which the gasket disposition part has a front-side disposition part that is disposed on a front surface of the plate-like member and a rear-side disposition part that is disposed on a rear surface of the plate-like member, the front-side disposition part has a continuous part that is provided to be recessed on the front surface and disposed around a desired sealing target region and an independent part that is provided to be recessed on the front surface, independent from the continuous part, and disposed on an outer side of the continuous part in a surface direction, the continuous part has a continuous part inner penetrating hole that penetrates the plate-like member in a front and rear direction and continues to the rear-side disposition part, the independent part has an independent part inner penetrating hole that penetrates the plate-like member in the front and rear direction and continues to the rear-side disposition part, the continuous part and the independent part communicate with each other through the continuous part inner penetrating hole, the rear-side disposition part, and the independent part inner penetrating hole, and, in the independent part, the gasket is disposed so as not to protrude forward from the front surface.

The gasket is integrally molded with the gasket disposition part of the plate-like member. Therefore, it is possible to reduce the man-hours compared with a method in which a separate gasket produced in advance is attached to a plate-like member. In addition, it is possible to determine the positions of the gasket and the plate-like member and integrate the gasket and the plate-like member at the same time as the molding of the gasket.

The plate-like member has a continuous part inner penetrating hole and an independent part inner penetrating hole. Therefore, it is possible to increase the contact area between the plate-like member and the gasket. Therefore, it is possible to suppress the deviation or dropping off of the gasket from the plate-like member in spite of the fact that the gasket is not attached to the plate-like member. In addition, the gasket is integrally molded with the front and rear (both) surfaces of the plate-like member through the continuous part inner penetrating hole and the independent part inner penetrating hole. Therefore, it is possible to suppress the deviation or dropping off of the gasket from the plate-like member due to an anchoring effect in spite of the fact that the gasket is not attached to the plate-like member.

The independent part is independent from the continuous part (that is, the sealing target region). In addition, the independent part is disposed on the outer side of the continuous part in the surface direction. Therefore, even in a case where a molding defect is generated in the gasket in the independent part (in detail, a part where the independent part is disposed in the gasket; hereinafter, similarly, “the gasket in an arbitrary part” refers to “a part disposed in the arbitrary part in the gasket”), in other words, even in a case where the shape accuracy of the gasket in the independent part is low, the shape accuracy is less likely to affect the gasket in the continuous part. Therefore, it is possible to suppress the deterioration of sealing properties attributed to the gasket in the independent part.

In the independent part, the gasket is disposed so as not to protrude forward from the front surface of the plate-like member. Therefore, even in a case where the shape accuracy of the gasket in the independent part is low, it is possible to suppress the deterioration of sealing properties attributed to the gasket in the independent part.

(2) In the above-described configuration, it may also be that the continuous part has a front-side groove part in which a sealing lip of the gasket protrudes forward from the front surface and a plurality of side protrusion parts that protrudes outward in a groove width direction from the front-side groove part, and the plurality of side protrusion parts has a plurality of penetrating side protrusion parts having the continuous part inner penetrating hole and a plurality of non-penetrating side protrusion parts having a continuous part inner non-penetrating hole that does not penetrate the plate-like member in the front and rear direction.

The plate-like member includes the front-side groove part, the penetrating side protrusion parts, the continuous part inner penetrating hole, the non-penetrating side protrusion parts, and the continuous part inner non-penetrating hole. Therefore, it is possible to increase the contact arca between the plate-like member and the gasket. Therefore, it is possible to suppress the deviation or dropping off of the gasket from the plate-like member in spite of the fact that the gasket is not attached to the plate-like member.

In the front side of the front-side groove part, the sealing lip of the gasket (in detail, a top part of the sealing lip that forms a sealing line) is disposed. On the other hand, the continuous part inner penetrating hole is disposed in the penetrating side protrusion part, and the continuous part inner non-penetrating hole is disposed in the non-penetrating side protrusion part, respectively. That is, the continuous part inner penetrating hole and the continuous part inner non-penetrating hole are not disposed in the front-side groove part. Therefore, even in a case where the shape accuracy of the gasket in the continuous part inner penetrating hole or the continuous part inner non-penetrating hole is low, the shape accuracy is less likely to affect the gasket in the front-side groove part. Therefore, it is possible to suppress the deterioration of sealing properties attributed to the gasket in the continuous part inner penetrating hole or the continuous part inner non-penetrating hole.

(3) In the above-described configuration, it may also be that the front surface exhibits a rectangular shape in a plan view, among surface directions of the front surface, a longitudinal direction is designated as an X direction, a widthwise direction is designated as a Y direction, the front-side groove part has a plurality of X-direction extension parts that extends in the X direction and a plurality of Y-direction extension parts that extends in the Y direction, the independent part includes an X-direction central part of the front surface, two independent parts are disposed on both outer sides of the plurality of X-direction extension parts in the Y direction, and, among the plurality of penetrating side protrusion parts, two penetrating side protrusion parts include a Y-direction central part of the front surface and are X-direction outer-end-side protrusion parts that are disposed on both outer sides of the plurality of Y-direction extension parts in the X direction.

The two independent parts are disposed at positions including the X-direction central part of the front surface. In addition, the two independent parts are disposed on both outer sides of the plurality of X-direction extension parts in the Y direction. In addition, the independent part inner penetrating hole is disposed in the independent part. Therefore, it is possible to suppress the deviation or dropping off of the gasket from the plate-like member at the positions including the X-direction central part of the front surface and on both outer sides of the front-side groove part in the Y direction.

The two X-direction outer-end-side protrusion parts are disposed at positions including the Y-direction central part of the front surface. In addition, the two X-direction outer-end-side protrusion parts are disposed on both outer sides of the plurality of Y-direction extension parts in the X direction. In addition, the continuous part inner penetrating hole is disposed in the X-direction outer-end-side protrusion part. Therefore, it is possible to suppress the deviation or dropping off of the gasket from the plate-like member at the positions including the Y-direction central part of the front surface and on both outer sides of the front-side groove part in the X direction.

(4) In the above-described configuration, it may also be that, among the plurality of penetrating side protrusion parts, two penetrating side protrusion parts include the X-direction central part of the front surface and are Y-direction outer-end-side protrusion parts that are disposed on both outer sides of the plurality of X-direction extension parts in the Y direction.

The two Y-direction outer-end-side protrusion parts are disposed at positions including the X-direction central part of the front surface. In addition, the two Y-direction outer-end-side protrusion parts are disposed on both outer sides of the plurality of X-direction extension parts in the Y direction. In addition, the continuous part inner penetrating hole is disposed in the Y-direction outer-end-side protrusion part. Therefore, it is possible to suppress the deviation or dropping off of the gasket from the plate-like member at the positions including the X-direction central part of the front surface and on both outer sides of the front-side groove part in the Y direction.

(5) In the above-described configuration, it may also be that the continuous part has a branching and merging section that connects the X-direction outer-end-side protrusion part and the Y-direction outer-end-side protrusion part, in the branching and merging section, a direction toward the X-direction outer-end-side protrusion part is designated as an upstream side, a direction toward the Y-direction outer-end-side protrusion part is designated as a downstream side, the branching and merging section has an upstream trunk part, a downstream trunk part that is disposed downstream of the upstream trunk part, a plurality of branch parts that is disposed between the upstream trunk part and the downstream trunk part, a branching part that connects a downstream end of the upstream trunk part and upstream ends of the plurality of branch parts, and a merging part that connects downstream ends of the plurality of branch parts and an upstream end of the downstream trunk part, among the plurality of penetrating side protrusion parts, at least one of the penetrating side protrusion parts is a merging-part side protrusion part that is disposed in the merging part, and, among the plurality of non-penetrating side protrusion parts, at least one of the non-penetrating side protrusion parts is a branch-part side protrusion part that is disposed in an arbitrary branch part among the plurality of branch parts.

According to the present configuration, the merging-part side protrusion part is disposed in the merging part. Therefore, it is possible to increase the contact area between the merging part and the gasket. In addition, the gasket is integrally molded with the front and rear (both) surfaces of the plate-like member through the continuous part inner penetrating hole in the merging-part side protrusion part. Therefore, it is possible to suppress the deviation or dropping off of the gasket from the merging part due to an anchoring effect. In addition, according to the present configuration, the merging-part side protrusion part is disposed in the branch part. Therefore, it is possible to increase the contact area between the branch part and the gasket.

(6) In the above-described configuration, it may also be that the penetrating side protrusion part exhibits a tapered shape having the continuous part inner penetrating hole at a groove-width-direction outer end, and the non-penetrating side protrusion part exhibits a tapered shape having the continuous part inner non-penetrating hole at a groove-width-direction outer end.

According to the present configuration, the continuous part inner penetrating hole is disposed at the groove-width-direction outer end of the penetrating side protrusion part. That is, in the penetrating side protrusion part, the continuous part inner penetrating hole is disposed at the position most separated from the front-side groove part. Therefore, even in a case where the shape accuracy of the gasket in the continuous part inner penetrating hole is low, the shape accuracy is less likely to affect the gasket in the front-side groove part. Therefore, it is possible to suppress the deterioration of sealing properties attributed to the gasket in the continuous part inner penetrating hole.

According to the present configuration, the continuous part inner non-penetrating hole is disposed at the groove-width-direction outer end of the non-penetrating side protrusion part. That is, in the non-penetrating side protrusion part, the continuous part inner non-penetrating hole is disposed at the position most separated from the front-side groove part. Therefore, even in a case where the shape accuracy of the gasket in the continuous part inner non-penetrating hole is low, the shape accuracy is less likely to affect the gasket in the front-side groove part. Therefore, it is possible to suppress the deterioration of sealing properties attributed to the gasket in the continuous part inner non-penetrating hole.

(7) In the above-described configuration, it may also be that the continuous part further has a front-side interposition part that is interposed between a plurality of the front-side groove parts adjacent to each other in the surface direction, and the front-side interposition part has the continuous part inner penetrating hole and the continuous part inner non-penetrating hole.

The front-side interposition part has the continuous part inner penetrating hole and the continuous part inner non-penetrating hole. Therefore, it is possible to increase the contact area between the front-side interposition part and the gasket. Therefore, it is possible to suppress the deviation or dropping off of the gasket from the front-side interposition part in spite of the fact that the gasket is not attached to the plate-like member. In addition, the gasket is integrally molded with the front and rear (both) surfaces of the plate-like member through the continuous part inner penetrating hole. Therefore, it is possible to suppress the deviation or dropping off of the gasket from the front-side interposition part due to an anchoring effect in spite of the fact that the gasket is not attached to the plate-like member.

(8) In the above-described configuration, it may also be that the rear-side disposition part has a rear-side groove part that is provided to be recessed on the rear surface and from which a scaling lip of the gasket protrudes rearward from the rear surface, a groove edge part that is disposed flush with the rear surface and stretches from the rear-side groove part outward in the surface direction, and a rear-side interposition part that is provided to be recessed on the rear surface and is interposed between a plurality of the rear-side groove parts adjacent to each other in the surface direction and in which the continuous part inner penetrating hole in the front-side interposition part is opened.

The rear-side disposition part includes the groove edge part that is flush with the rear surface of the plate-like member. Therefore, the gasket in the groove edge part makes it possible to dispose a surface sealing part on the rear surface. In addition, in the rear-side disposition part, the continuous part inner penetrating hole in the front-side disposition part is opened. Therefore, it is possible to increase the contact area between the plate-like member and the gasket. In addition, it is possible to suppress the deviation or dropping off of the gasket from the rear-side disposition part due to an anchoring effect in spite of the fact that the gasket is not attached to the first separator. Particularly, in the rear-side interposition part, the continuous part inner penetrating hole in the front-side interposition part is opened. Therefore, between the front-side interposition part and the rear-side interposition part, it is possible to increase the contact area between the plate-like member and the gasket. In addition, it is possible to suppress the deviation or dropping off of the gasket from the rear-side interposition part due to an anchoring effect in spite of the fact that the gasket is not attached to the first separator.

(9) In the above-described configuration, it may also be that a membrane electrode assembly that is disposed on the rear surface of the plate-like member and has an electrolyte film and a pair of catalyst layers that are disposed on front and rear (both) surfaces of the electrolyte film is further provided, and the gasket is integrally molded with the plate-like member and the membrane electrode assembly.

The gasket is integrally molded with the plate-like member and the membrane electrode assembly. Therefore, it is possible to reduce the man-hours compared with a method in which a separate gasket produced in advance is attached to a plate-like member and a membrane electrode assembly is laminated on the plate-like member. In addition, it is possible to determine the positions of the gasket, the plate-like member, and the membrane electrode assembly and integrate the gasket, the plate-like member, and the membrane electrode assembly at the same time as the molding of the gasket.

(10) In a method for manufacturing the fuel cell composite member having any one of

the above-described configurations, the method has a disposition step of disposing the plate-like member in a cavity of a mold so that a gate of the mold faces the continuous part and a raw material injection step of injecting a raw material of the gasket into the cavity from the gate, causing the raw material to flow into the continuous part, causing the raw material to flow from the continuous part to the rear-side disposition part through the continuous part inner penetrating hole, and causing the raw material to flow from the rear-side disposition part to the independent part through the independent part inner penetrating hole.

The fuel cell composite member that is manufactured according to the present configuration has the same effect as the configuration of the (1). According to the present configuration, in the raw material injection step, the raw material of the gasket flows around the rear-side disposition part and then arrives at the independent part in the end. Therefore, it is possible to suppress the generation of a molding defect attributed to the flow in the rear-side disposition part.

(11) In the configuration of the (10), it may also be that the continuous part has a front-side groove part in which a sealing lip of the gasket protrudes forward from the front surface and a plurality of side protrusion parts that protrudes outward in a groove width direction from the front-side groove part, and the plurality of side protrusion parts has a plurality of penetrating side protrusion parts having the continuous part inner penetrating hole and a plurality of non-penetrating side protrusion parts having a continuous part inner non-penetrating hole that does not penetrate the plate-like member in the front and rear direction.

The fuel cell composite member that is manufactured according to the present configuration has the same effect as the configuration of the (2). According to the present configuration, in the raw material injection step, the raw material of the gasket flows into the continuous part inner penetrating hole through the penetrating side protrusion part. Since the raw material flows through the penetrating side protrusion part, it is possible to suppress the entrainment of an air when the raw material flows into the continuous part inner penetrating hole. Therefore, it is possible to suppress the generation of a molding defect in the rear-side disposition part.

(12) In any configuration of the (10) or later (including (10), which will be true below), it may also be that the front surface exhibits a rectangular shape in a plan view, among surface directions of the front surface, a longitudinal direction is designated as an X direction, a widthwise direction is designated as a Y direction, the front-side groove part has a plurality of X-direction extension parts that extends in the X direction and a plurality of Y-direction extension parts that extends in the Y direction, the independent part includes an X-direction central part of the front surface, two independent parts are disposed on both outer sides of the plurality of X-direction extension parts in the Y direction, among the plurality of penetrating side protrusion parts, two penetrating side protrusion parts include a Y-direction central part of the front surface and are X-direction outer-end-side protrusion parts that are disposed on both outer sides of the plurality of

Y-direction extension parts in the X direction, and, in the disposition step, the plate-like member is disposed in the cavity of the mold so that the gate faces the X-direction outer-end-side protrusion parts.

The fuel cell composite member that is manufactured according to the present configuration has the same effect as the configuration of the (3). In the raw material injection step, the raw material of the gasket flows from the two X-direction outer-end-side protrusion parts up to the two independent parts through the rear-side disposition part. According to the present configuration, it is possible to suppress a variation in flow path length when the raw material of the gasket flows. Therefore, it is possible to suppress the generation of a molding defect attributed to the variation.

(13) In any configuration of the (10) or later, it may also be that, among the plurality of penetrating side protrusion parts, two penetrating side protrusion parts include the X-direction central part of the front surface and are Y-direction outer-end-side protrusion parts that are disposed on both outer sides of the plurality of X-direction extension parts in the Y direction.

The fuel cell composite member that is manufactured according to the present configuration has the same effect as the configuration of the (4). In the raw material injection step, the raw material of the gasket flows from the two X-direction outer-end-side protrusion parts up to the two Y-direction outer-end-side protrusion parts through the front-side disposition part. According to the present configuration, it is possible to suppress a variation in flow path length when the raw material of the gasket flows. Therefore, it is possible to suppress the generation of a molding defect attributed to the variation.

(14) In any configuration of the (10) or later, it may also be that the continuous part has

a branching and merging section that connects the X-direction outer-end-side protrusion part and the Y-direction outer-end-side protrusion part, in the branching and merging section, a direction toward the X-direction outer-end-side protrusion part is designated as an upstream side, a direction toward the Y-direction outer-end-side protrusion part is designated as a downstream side, the branching and merging section has an upstream trunk part, a downstream trunk part that is disposed downstream of the upstream trunk part, a plurality of branch parts that is disposed between the upstream trunk part and the downstream trunk part, a branching part that connects a downstream end of the upstream trunk part and upstream ends of the plurality of branch parts, and a merging part that connects downstream ends of the plurality of branch parts and an upstream end of the downstream trunk part, among the plurality of penetrating side protrusion parts, at least one of the penetrating side protrusion parts is a merging-part side protrusion part that is disposed in the merging part, and, among the plurality of non-penetrating side protrusion parts, at least one of the non-penetrating side protrusion parts is a branch-part side protrusion part that is disposed in an arbitrary branch part among the plurality of branch parts.

The fuel cell composite member that is manufactured according to the present configuration has the same effect as the configuration of the (5). In the raw material injection step, the raw material of the gasket flows through the branching and merging section in a direction of “the X-direction outer-end-side protrusion part→the upstream trunk part→the branching part→the plurality of branch parts→the merging part→the downstream trunk part→the Y-direction outer-end-side protrusion part.” The shapes (the extension shape, cross-sectional shape, and the like of the flow path), flow path lengths, and the like of the plurality of branch parts are not constant. Therefore, the flow path resistance of the plurality of branch parts is likely to vary. Therefore, the timing of the raw material of the gasket that flows through the plurality of branch parts merging in the merging part is also likely to vary.

Regarding this point, according to the present configuration, among the plurality of branch parts, the branch-part side protrusion part is disposed in an arbitrary branch part. Therefore, it is possible to slow the flow rate of the raw material of the gasket in the branch part. Therefore, it is possible to suppress a variation in the flow path resistance of the plurality of branch parts by appropriately disposing the branch-part side protrusion part in, among the plurality of branch parts, a branch part where the flow rate of the raw material of the gasket is fast (which may be singular or plural). Therefore, it is possible to suppress a variation in the timing of the raw material of the gasket that flows through the plurality of branch parts merging in the merging part. Therefore, it is possible to suppress the generation of a molding defect attributed to the timing variation.

(15) In any configuration of the (10) or later, it may also be that the penetrating side protrusion part exhibits a tapered shape having the continuous part inner penetrating hole at a groove-width-direction outer end, and the non-penetrating side protrusion part exhibits a tapered shape having the continuous part inner non-penetrating hole at a groove-width-direction outer end.

The fuel cell composite member that is manufactured according to the present configuration has the same effect as the configuration of the (6). In the raw material injection step, the raw material of the gasket flows into the continuous part inner penetrating hole through the penetrating side protrusion part. The penetrating side protrusion part of the present configuration exhibits a tapered shape that becomes gradually narrower toward the groove-width-direction outer end. The continuous part inner penetrating hole is disposed at the tapered top part of the penetrating side protrusion part. Therefore, the raw material of the gasket stays in the penetrating side protrusion part (flows from the hem part (the groove-width-direction inner end) of the penetrating side protrusion part toward the taping top part (the groove-width-direction outer end)) and then flows into the continuous part inner penetrating hole through the penetrating side protrusion part. Therefore, it is possible to suppress the entrainment of an air. Therefore, it is possible to suppress the generation of a molding defect in the rear-side disposition part.

In the raw material injection step, the raw material of the gasket flows along the front-side groove part. The penetrating side protrusion part of the present configuration exhibits a tapered shape that becomes gradually narrower toward the groove-width-direction outer end. Therefore, it is possible to partially adjust the flow path width of the raw material of the gasket in the front-side disposition part. This is also true for the non-penetrating side protrusion part. In addition, the continuous part inner non-penetrating hole is disposed at the tapered top part of the non-penetrating side protrusion part. Therefore, it is possible to partially adjust the flow path depth of the raw material of the gasket in the front-side disposition part.

(16) In any configuration of the (10) or later, it may also be that the continuous part further has a front-side interposition part that is interposed between a plurality of the front-side groove parts adjacent to each other in the surface direction, and the front-side interposition part has the continuous part inner penetrating hole and the continuous part inner non-penetrating hole.

The fuel cell composite member that is manufactured according to the present configuration has the same effect as the configuration of the (7). According to the present configuration, in the raw material injection step, it is possible to cause the raw material of the gasket to flow from the front-side disposition part toward the rear-side disposition part through the continuous part inner penetrating hole in the front-side interposition part.

(17) In any configuration of the (10) or later, it may also be that the rear-side disposition part has a rear-side groove part that is provided to be recessed on the rear surface and from which a sealing lip of the gasket protrudes rearward from the rear surface, a groove edge part that is disposed flush with the rear surface and stretches from the rear-side groove part outward in the surface direction, and a rear-side interposition part that is provided to be recessed on the rear surface and is interposed between a plurality of the rear-side groove parts adjacent to each other in the surface direction and in which the continuous part inner penetrating hole in the front-side interposition part is opened.

The fuel cell composite member that is manufactured according to the present configuration has the same effect as the configuration of the (8). According to the present configuration, in the raw material injection step, it is possible to directly cause the raw material of the gasket to flow from the front-side interposition part toward the rear-side interposition part through the continuous part inner penetrating hole in the front-side interposition part.

(18) In any configuration of the (10) or later, it may also be that a membrane electrode assembly that is disposed on the rear surface of the plate-like member and has an electrolyte film and a pair of catalyst layers that are disposed on front and rear (both) surfaces of the electrolyte film is further provided, and, in the disposition step, the membrane electrode assembly is disposed in the cavity together with the plate-like member, thereby integrally molding the gasket with the plate-like member and the membrane electrode assembly.

The fuel cell composite member that is manufactured according to the present configuration has the same effect as the configuration of the (9). According to the present configuration, it is possible to integrally mold the gasket with the plate-like member and the membrane electrode assembly.

According to the fuel cell composite member of the disclosure and the manufacturing method therefor, it is possible to suppress the deterioration of sealing properties.

Hereinafter, embodiments of a fuel cell composite member of the disclosure and a manufacturing method therefor will be described. In the following drawings, the upper side corresponds to the “front side” of the disclosure, and the lower side corresponds to the “rear side” of the disclosure, respectively. In addition, the right and left direction (longitudinal direction) corresponds to the “X direction” of the disclosure, and the front and rear direction (widthwise direction) corresponds to the “Y direction” of the disclosure, respectively.

### First Embodiment

### Stack

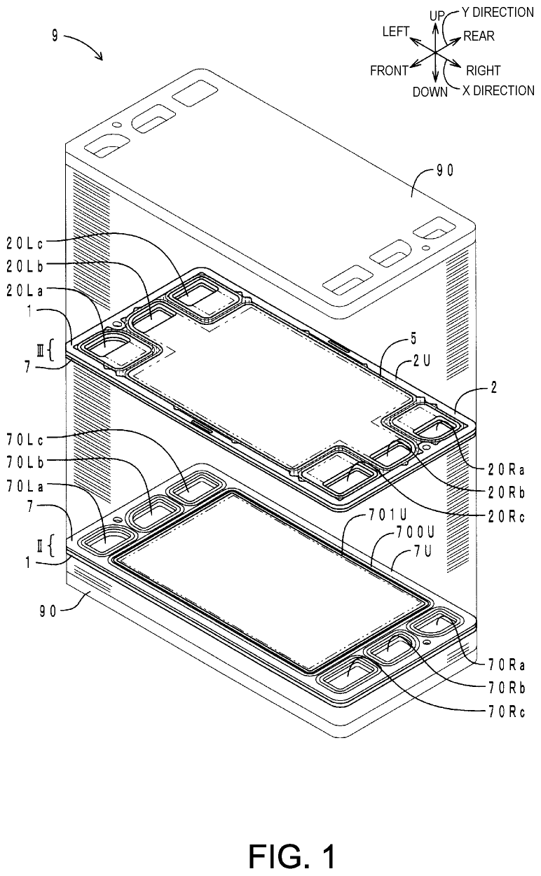

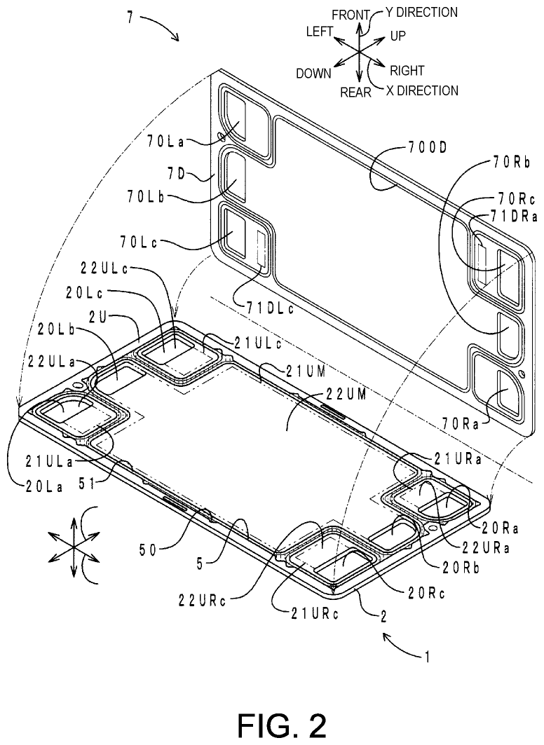

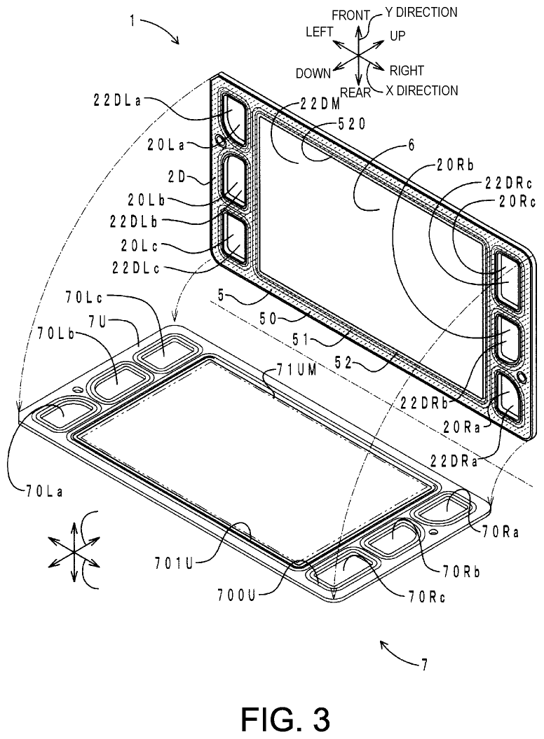

First, the configuration of a stack of fuel cells including a fuel cell composite member of the present embodiment will be simply described. FIG. 1 shows a perspective view of the stack of fuel cells including the fuel cell composite member of the present embodiment. FIG. 2 shows an exploded perspective view of a part II in FIG. 1. FIG. 3 shows an exploded perspective view of a part III in FIG. 1. In FIG. 1 to FIG. 3, a gasket 5 is hatched with dotted lines.

As shown in FIG. 1 to FIG. 3, a stack 9 includes a pair of end plates 90, a plurality of fuel cell composite members 1, and a plurality of second separators 7. The fuel cell composite members 1 and the second separators 7 are alternately laminated in the vertical direction (lamination direction).

As shown in FIG. 2, a lower surface 7D of the second separator 7 is laminated on an

upper surface 2U of the fuel cell composite member 1. On the upper surface 2U of the fuel cell composite member 1, five sealing target regions 22ULa, 22ULc, 22URa, 22URc, and 22UM are set. In addition, on the upper surface 2U, a vinyl methyl silicone rubber (VMQ) gasket 5 is disposed. The gasket 5 is clastically in contact with a rear-side groove part 700D of the lower surface 7D of the second separator 7. Due to the elastic contact, the gasket 5 isolates the five sealing target regions 22ULa. 22ULc, 22URa, 22URc, and 22UM from the outer side. In addition, the gasket 5 isolates the five sealing target regions 22ULa, 22ULc, 22URa, 22URc, and 22UM from each other.

As shown in FIG. 3, a lower surface 2D of the fuel cell composite member 1 is laminated on an upper surface 7U of the second separator 7. On the lower surface 2D of the fuel cell composite member 1, seven sealing target regions 22DLa. 22DLb, 22DLc, 22DRa, 22DRb, 22DRc, and 22DM are set. In addition, on the lower surface 2D, a gasket 5 integrated with the gasket 5 on the upper surface 2U is disposed. The gasket 5 is elastically in contact with the upper surface 7U itself of the second separator 7, a front surface groove part 700U of the upper surface 7U, and a holding part accommodation groove part 701U of the upper surface 7U. Due to the clastic contact, the gasket 5 isolates the seven sealing target regions 22DLa, 22DLb, 22DLc. 22DRa, 22DRb, 22DRc, and 22DM from the outer side. In addition, the gasket 5 isolates the seven sealing target regions 22DLa, 22DLb, 22DLc, 22DRa, 22DRb, 22DRc, and 22DM from each other.

### Fuel Cell Composite Member 1

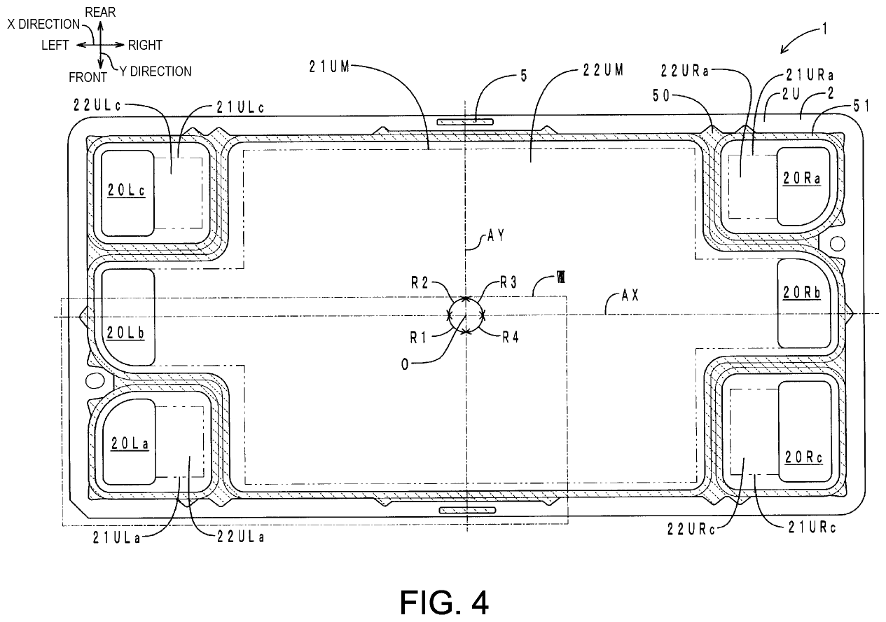

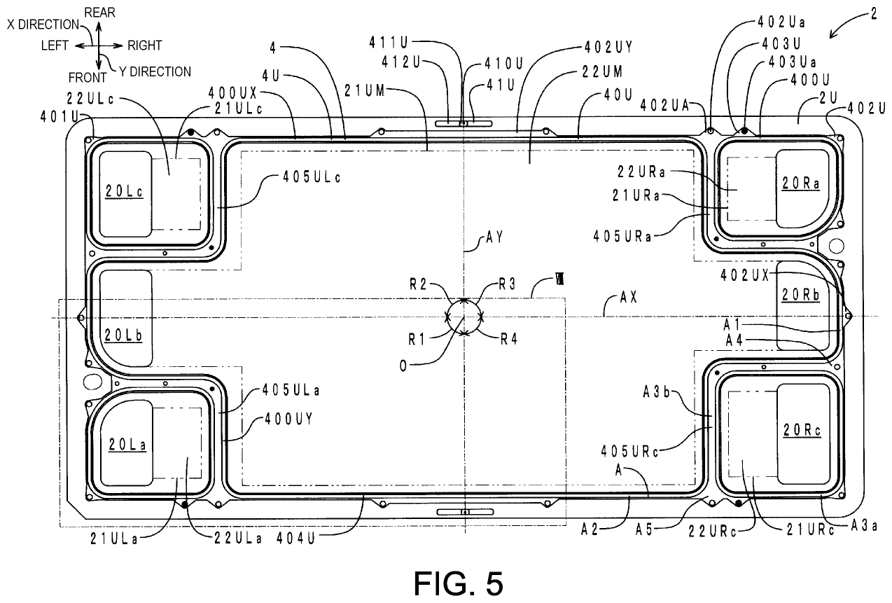

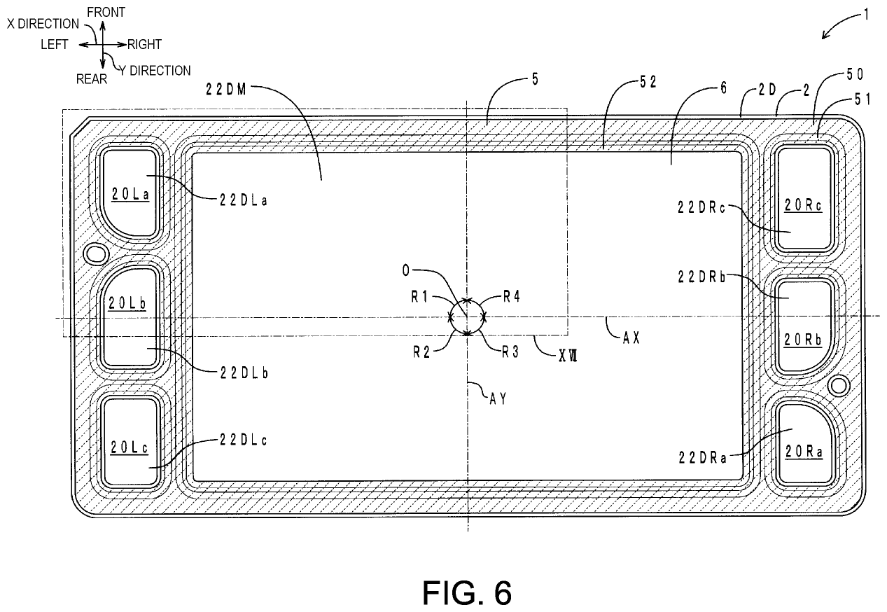

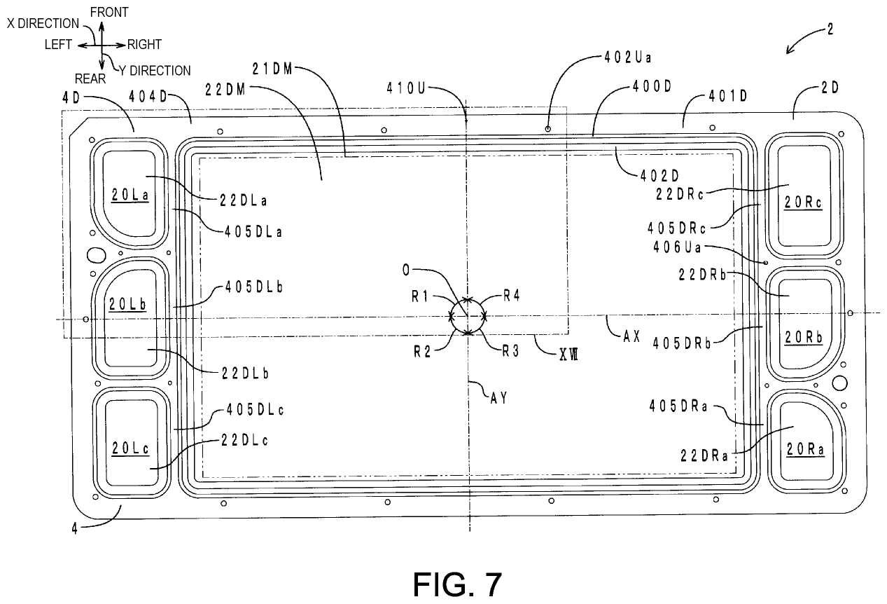

Next, the configuration of the fuel cell composite member of the present embodiment will be described. FIG. 4 shows a top view of the fuel cell composite member of the present embodiment. FIG. 5 shows a top view of a first separator of the fuel cell composite member of the present embodiment. FIG. 6 shows a bottom view of the fuel cell composite member of the present embodiment. FIG. 7 shows a bottom view of the first separator of the fuel cell composite member of the present embodiment. In FIG. 4 and FIG. 6, the gasket 5 is hatched with dotted lines. In addition, in FIG. 5, continuous part inner non-penetrating holes 403Ua that do not penetrate a first separator 2 are indicated in black (the holes are filled with black color).

As shown in FIG. 4 to FIG. 7, the fuel cell composite member 1 includes the first separator 2, the gasket 5, and a membrane electrode gas diffusion layer assembly (MEGA) 6. The first separator (bipolar plate) 2 is included in the concept of “plate-like member” of the disclosure.

### First Separator 2

The first separator 2 is made of a conductive resin and exhibits a rectangular thin plate shape. An upper surface 2U of the first separator 2 exhibits a rectangular shape (when seen from above) in a plan view. The first separator 2 includes six manifolds 20La to 20Lc and 20Ra to 20Rc and a gasket disposition part 4.

### Manifolds 20La to 20Lc and 20Ra to 20Rc

Each of the six manifolds 20La to 20Lc and 20Ra to 20Rc penetrates the first separator 2 in the vertical direction (front and rear direction or lamination direction). Among them, the three manifolds 20La to 20Lc are arranged from the front side toward the rear side along the left edge of the first separator 2. The remaining three manifolds 20Ra to 20Rc are arranged from the rear side toward the front side along the right edge of the first separator 2.

### Flow Path Regions 21ULa, 21ULc, 21URa, 21URc, and 21UM

As shown by dashed-two dotted lines in FIG. 4 and FIG. 5, on the upper surface (front surface) 2U of the first separator 2, a flow path region 21ULa is disposed on the right side (inside in the surface direction) of the manifold 20La, a flow path region 21ULc is disposed on the right side of the manifold 20Lc, a flow path region 21URa is disposed on the left side (inside in the surface direction) of the manifold 20Ra, and a flow path region 21URc is disposed on the left side of the manifold 20Rc, respectively. In addition, in the middle in the right and left direction (inside in the surface direction) between the manifold 20Lb and the manifold 20Rb, a flow path region 21UM is disposed.

As shown by a dashed-two dotted line in FIG. 7, on a lower surface (rear surface) 2D of the first separator 2, a flow path region 21DM is disposed in the middle in the right and left direction between the three manifolds 20La to 20Lc on the left side and the three manifolds 20Ra to 20Rc on the right side. In each of these flow path regions 21ULa. 21ULc. 21URa, 21URc. and 21DM, a plurality of groove parts (not shown) for fluids (hydrogen, air, and cooling water) is provided to be recessed.

### Sealing Target Regions 22ULa, 22ULc, 22URa, 22URc, 22UM, 22DLa, 22DLb, 22DLc, 22DRa, 22DRb, 22DRc, and 22DM

As shown in FIG. 4 and FIG. 5, on the upper surface 2U, the five sealing target regions 22ULa, 22ULc, 22URa, 22URc, and 22UM are set. The sealing target region 22ULa includes the manifold 20La and the flow path region 21ULa. The sealing target region 22ULc includes the manifold 20Lc and the flow path region 21ULc. The sealing target region 22URa includes the manifold 20Ra and the flow path region 21URa. The sealing target region 22URc includes the manifold 20Rc and the flow path region 21URc. The sealing target region 22UM includes the manifolds 20La and 20Rb and the flow path region 21UM.

As shown in FIG. 7, on the lower surface 2D, the seven sealing target regions 22DLa, 22DLb, 22DLc. 22DRa, 22DRb, 22DRc, and 22DM are set. The sealing target region 22DLa includes the manifold 20La. The sealing target region 22DLb includes the manifold 20Lb. The scaling target region 22DLc includes the manifold 20Lc. The sealing target region 22DRa includes the manifold 20Ra. The sealing target region 22DRb includes the manifold 20Rb. The scaling target region 22DRc includes the manifold 20Rc. The sealing target region 22DM includes the flow path region 21DM and MEGA 6, which will be described below, (refer to FIG. 6).

### Gasket Disposition Part 4

As shown in FIG. 5 and FIG. 7, the gasket disposition part 4 includes a front-side disposition part 4U and a rear-side disposition part 4D. The gasket 5 is integrally formed with the gasket disposition part 4.

### Front-Side Disposition Part 4U

The front-side disposition part 4U is disposed on the upper surface 2U. The front-side disposition part 4U is disposed around the five sealing target regions 22ULa, 22ULc, 22URa, 22URc, and 22UM.

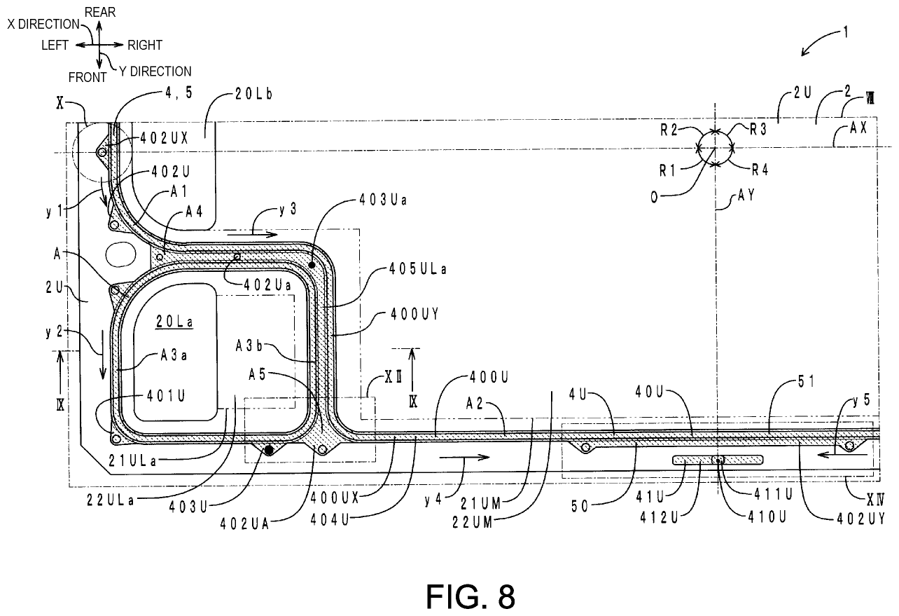

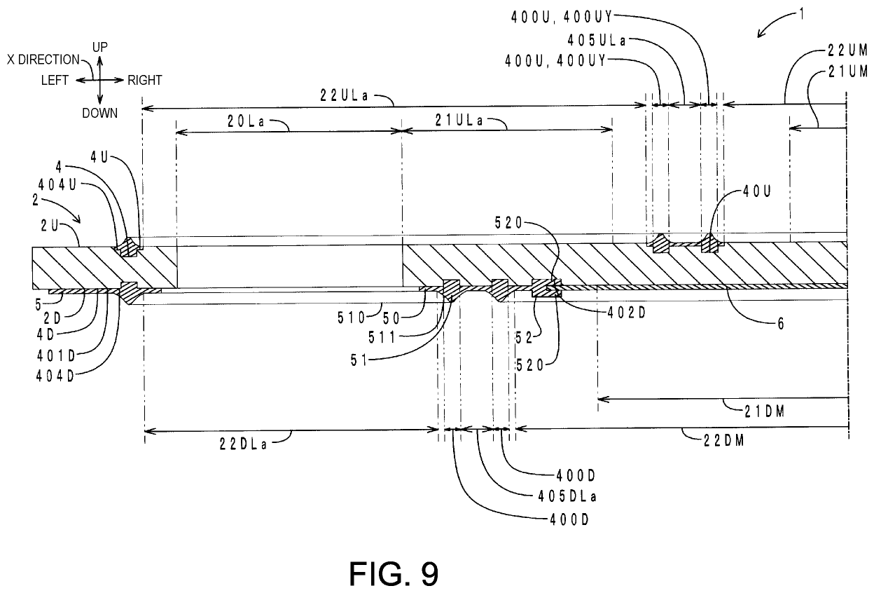

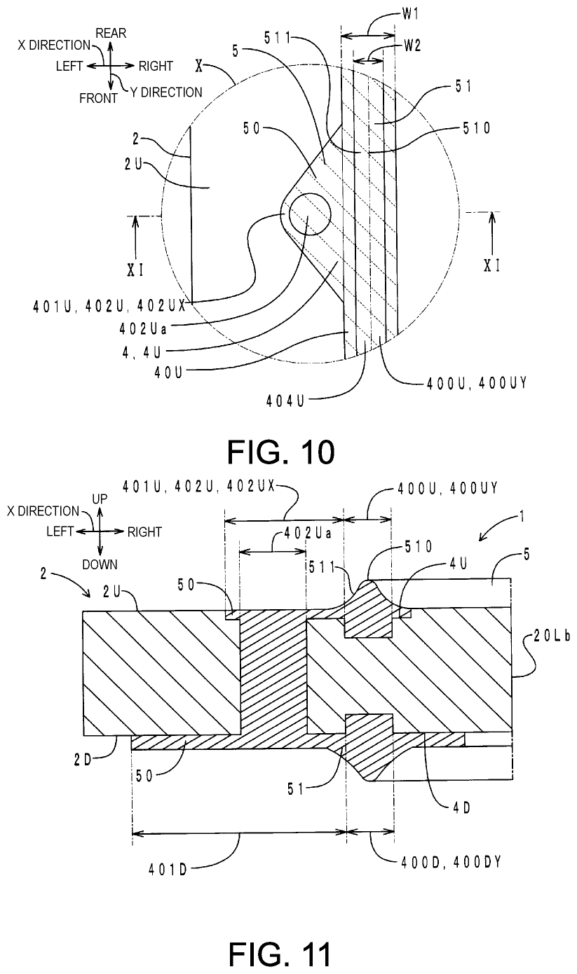

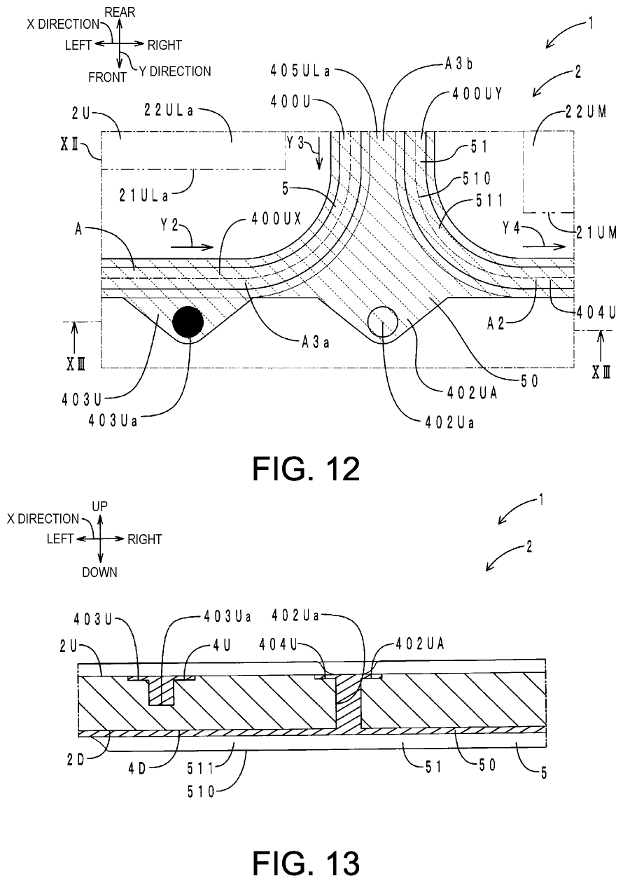

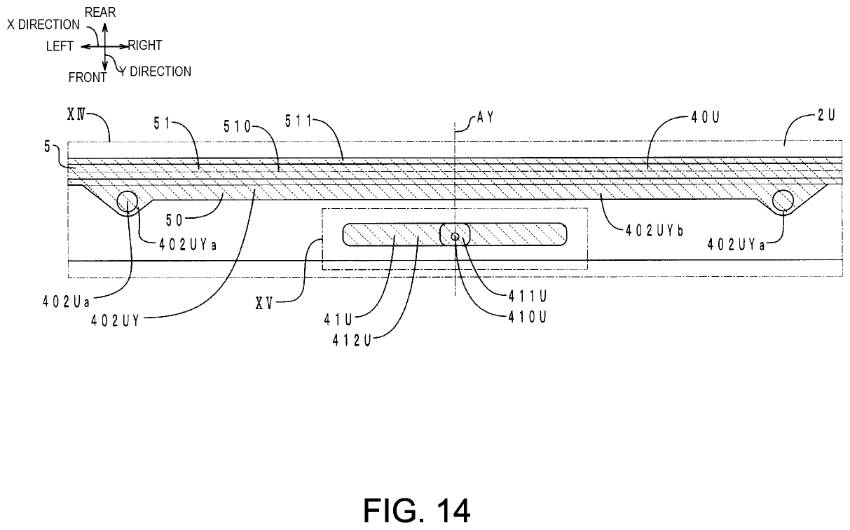

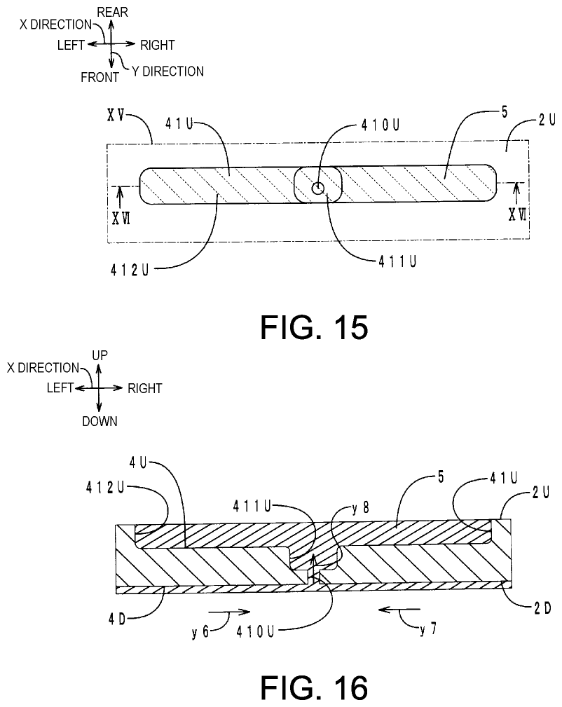

FIG. 8 shows an enlarged view of the inside of a frame VIII in FIG. 4. FIG. 9 shows a cross-sectional view in an IX-IX direction of FIG. 8. FIG. 10 shows an enlarged view of the inside of a circle X in FIG. 8. FIG. 11 shows a cross-sectional view in an XI-XI direction of FIG. 10. FIG. 12 shows an enlarged view of the inside of a frame XII in FIG. 8. FIG. 13 shows a cross-sectional view in an XIII-XIII direction of FIG. 12. FIG. 14 shows an enlarged view of the inside of a frame XIV in FIG. 8. FIG. 15 shows an enlarged view of the inside of a frame XV in FIG. 14. FIG. 16 shows a cross-sectional view in an XVI-XVI direction of FIG. 15.

In FIG. 8 and the partial enlarged views of FIG. 8 (FIG. 10, FIG. 12, FIG. 14, and FIG. 15), the gasket 5 is hatched with dotted lines. In addition, in FIG. 8 and the partial enlarged views of FIG. 8, the first separator 2 is shown through the gasket 5. In addition, in FIG. 8 and FIG. 12, the continuous part inner non-penetrating holes 403Ua that do not penetrate the first separator 2 are indicated in black (the holes are filled with black color). As shown in FIG. 5 and FIG. 8, the front-side disposition part 4U includes a continuous part 40U and two independent parts 41U.

### Continuous Part 40U

As shown in FIG. 9, the continuous part 40U is provided to be recessed on the supper surface 2U. As shown in FIG. 5 and FIG. 8, the continuous part 40U includes a front-side groove part 400U, a plurality of side protrusion parts 401U, a front side outer frame part 404U, four front-side interposition parts 405ULa, 405ULc, 405URa, and 405URc, and four branching and merging sections A.

### Front-Side Groove Part 400U

As shown in FIG. 9, sealing lips 51 of the gasket 5 protrude from the front-side groove part 400U upward relative to the upper surface 2U. As shown in FIG. 11, a groove bottom part of the front-side groove part 400U is disposed on the lower side (at a deeper position) of the recess bottom portions of the side protrusion parts 401U. The continuous part 40U exhibits a two-stage bottom shape.

As shown in FIG. 8, the front-side groove part 400U includes a plurality of X-direction extension parts 400UX and a plurality of Y-direction extension parts 400UY. The X-direction extension parts 400UX extend in the right and left direction. The Y-direction extension parts 40QUY extend in the front and rear direction. As shown in FIG. 10, a groove width W2 of the front-side groove part 400U is narrower than a lip width W1 of the sealing lip 51. In a plan view, a top part 510 of the sealing lip 51 is disposed in the groove of the front-side groove part 400U.

### Side Protrusion Part 401U

As shown in FIG. 8, in a plan view, the side protrusion part 401U protrudes from the front-side groove part 400U outward in the groove width direction. The side protrusion part 401U exhibits a tapered shape that becomes gradually narrower from the groove-width-direction inside toward the groove-width-direction outer side. The plurality of side protrusion parts 401U has a plurality of penetrating side protrusion parts 402U and four non-penetrating side protrusion parts 403U. The non-penetrating side protrusion parts 403U correspond to “branch-part side protrusion parts” of the disclosure.

### Penetrated Side Protrusion Part 402U

As shown in FIG. 10 to FIG. 14, the penetrating side protrusion part 402U has a continuous part inner penetrating hole 402Ua. The continuous part inner penetrating hole 402Ua is disposed at the groove-width-direction outer end (tapered top part) of the penetrating side protrusion part 402U. The continuous part inner penetrating hole 402Ua penetrates the first separator 2 in the vertical direction (front and rear direction). The continuous part inner penetrating hole 402Ua continues to the rear-side disposition part 4D.

As shown in FIG. 5, FIG. 8, and FIG. 10 to FIG. 14, the plurality of penetrating side protrusion parts 402U has two X-direction outer-end-side protrusion parts 402UX (particularly in FIG. 10), two Y-direction outer-end-side protrusion parts 402UY (particularly in FIG. 14), and four merging-part side protrusion parts 402UA (particularly in FIG. 12).

As shown in FIG. 5, the two X-direction outer-end-side protrusion parts 402UX are disposed at positions including an axis AX of the upper surface 2U. The axis AX extends in the right and left direction through the front and rear-direction center of the upper surface 2U and the lower surface 2D. The axis AX is included in the concept of “Y-direction central part” of the disclosure. The two X-direction outer-end-side protrusion parts 402UX are disposed on both outer sides of all of the Y-direction extension parts 40QUY in the right and left direction. As shown in FIG. 10, the X-direction outer-end-side protrusion part 402UX exhibits, like other penetrating side protrusion parts 402U, a triangular shape that becomes sharper outward in the groove width direction.

As shown in FIG. 5, the two Y-direction outer-end-side protrusion parts 402UY are disposed at positions including an axis AY on the upper surface 2U. The axis AY extends in the front and rear direction through the right and left-direction center of the upper surface 2U and the lower surface 2D. The axis AY is included in the concept of “X-direction central part” of the disclosure. The two Y-direction outer-end-side protrusion parts 402UY are disposed on both outer sides of all of the X-direction extension parts 400UX in the front and rear direction. As shown in FIG. 14, the Y-direction outer-end-side protrusion part 402UY exhibits, unlike other penetrating side protrusion parts 402U, a shape in which two penetrating side protrusion parts 402U continue in the right and left direction. That is, the Y-direction outer-end-side protrusion part 402UY includes two triangular parts 402UYa and a connection part 402UYb. The triangular part 402UYa exhibits, like other penetrating side protrusion parts 402U, a triangular shape that becomes sharper outward in the groove width direction. The two triangular parts 402UYa are disposed apart from each other in the right and left direction across the axis AY. The connection part 402UYb exhibits a band shape that is long in the right and left direction. The connection part 402UYb is disposed in the middle between the two triangular parts 402UYa astride the axis AY. The connection part 402UYb connects the two triangular parts 402UYa in the right and left direction. As a whole, the Y-direction outer-end-side protrusion part 402UY exhibits a tapered shape that becomes sharper outward in the groove width direction.

As shown in FIG. 5, the four merging-part side protrusion parts 402UA are disposed in four regions R1 to R4 that are set by dividing the first separator 2 with the axes AX and AY (a left front region R1, a left rear region R2, a right rear region R3, and a right front region R4 around an intersection point O clockwise in a plan view as shown in FIG. 5) one by one. The merging-part side protrusion part 402UA is disposed at a portion where a Y-direction end part (front end part, rear end part) of the Y-direction extension part 400UY continues to a middle part of the X-direction extension part 400UX. The merging-part side protrusion part 402UA is disposed in a merging part A5, which will be described below.

### Non-Penetrating Side Protrusion Part 403U

As shown in FIG. 5, FIG. 8, and FIG. 12 and FIG. 13, the non-penetrating side protrusion part (branch-part side protrusion part) 403U has the continuous part inner non-penetrating hole 403Ua. The continuous part inner non-penetrating hole 403Ua is disposed at the groove-width-direction outer end (tapered top part) of the non-penetrating side protrusion part 403U. The continuous part inner non-penetrating hole 403Ua does not penetrate the first separator 2 in the vertical direction. The continuous part inner non-penetrating hole 403Ua exhibits a bottomed recess part shape.

As shown in FIG. 5, the four non-penetrating side protrusion parts 403U are disposed in the four regions R1 to R4 one by one. The non-penetrating side protrusion part 403U is disposed adjacent to (on the outer side in the surface direction of) the merging-part side protrusion part 402UA. The non-penetrating side protrusion part 403U is disposed in an outer circumferential branch part A3a, which will be described below.

### Front Side Outer Frame Part 404U and Front-Side Interposition Parts 405ULa, 405ULc, 405URa, and 405URc

As shown in FIG. 5, the front side outer frame part 404U extends in a rectangular frame shape along the outer edge of the upper surface 2U. In the front side outer frame part 404U, the front-side groove part 400U is disposed along the extension direction of the front side outer frame part 404U. In addition, in the front side outer frame part 404U, the side protrusion parts 401U are disposed to protrude outward in the surface direction from the front-side groove part 400U in the front side outer frame part 404U.

As shown in FIG. 5, the four front-side interposition parts 405ULa, 405ULc, 405URa, and 405URc are disposed in the four regions R1 to R4 one by one. The four front-side interposition parts 405ULa, 405ULc, 405URa, and 405URc are each disposed in an L shape on the inside in the surface direction of the four corners of the front side outer frame part 404U. Specifically, the front-side interposition part 405ULa is disposed between the sealing target region 22ULa and the sealing target region 22UM. The front-side interposition part 405ULc is disposed between the sealing target region 22ULc and the sealing target region 22UM. The front-side interposition part 405URa is disposed between the sealing target region 22URa and the scaling target region 22UM. The front-side interposition part 405URc is disposed between the scaling target region 22URc and the sealing target region 22UM.

As an example, the front-side interposition part 405ULa in the region R1 shown in FIG. 8 is disposed between the X-direction extension part 400UX close to the sealing target region 22 ULa and the X-direction extension part 400UX close to the sealing target region 22UM. Additionally, the front-side interposition part 405ULa is disposed between the Y-direction extension part 400UY close to the sealing target region 22 ULa and the Y-direction extension part 400UY close to the sealing target region 22UM. That is, the front-side interposition part 405ULa is interposed between two front-side groove parts 400U adjacent to each other in the surface direction.

The front-side interposition part 405ULa includes the continuous part inner penetrating hole 402Ua and the continuous part inner non-penetrating hole 403Ua shown in FIG. 13. This is also true for the front-side interposition part 405ULc in the region R2, the front-side interposition part 405URa in the region R3, and the front-side interposition part 405URc in the region R4.

### Branching and Merging Section A

As shown in FIG. 5, four branching and merging sections A are disposed in the regions

R1 to R4 one by one. The four branching and merging sections A correspond to the four front-side interposition parts 405ULa, 405ULc, 405URa, and 405URc.

As an example, the branching and merging section A in the region R1 shown in FIG. 8 connects the X-direction outer-end-side protrusion part 402UX in the boundary between the region R1 and the region R2 and the Y-direction outer-end-side protrusion part 402UY in the boundary between the region R1 and the region R4. That is, the branching and merging sections A connects the X-direction outer-end-side protrusion part 402UX and the Y-direction outer-end-side protrusion part 402UY, which are adjacent to each other in the circumferential direction of the first separator 2 in a plan view.

The branching and merging section A includes an upstream trunk part A1, a downstream trunk part A2, the outer circumferential branch part A3a, an inner circumferential branch part A3b, a branching part A4, and the merging part A5. The outer circumferential branch part A3a and the inner circumferential branch part A3b are included in the concept of “branch part” of the disclosure. Herein, in the branching and merging sections A, a direction toward the X-direction outer-end-side protrusion part 402UX is defined as the upstream side, and a direction toward the Y-direction outer-end-side protrusion part 402UY is defined as the downstream side.

The upstream trunk part A1 continues to the X-direction outer-end-side protrusion part 402UX. The downstream trunk part A2 continues to the Y-direction outer-end-side protrusion part 402UY. The outer circumferential branch part A3a and the inner circumferential branch part A3b are each disposed between the upstream trunk part A1 and the downstream trunk part A2. The outer circumferential branch part A3a bypasses the sealing target region 22ULa along the outer side in the surface direction. The inner circumferential branch parts A3b bypasses the sealing target region 22ULa along the inside in the surface direction. The branching part A4 connects the downstream end of the upstream trunk part A1, the upstream end of the outer circumferential branch part A3a, and the upstream end of the inner circumferential branch part A3b. The merging part A5 connects the upstream end of the downstream trunk part A2, the downstream end of the outer circumferential branch part A3a, and the downstream end of the inner circumferential branch part A3b.

### Independent Part 41U

As shown in FIG. 16, the independent part 41U is provided to be recessed on the upper surface 2U. As shown in FIG. 5 and FIG. 14, on the upper surface 2U, the independent parts 41U are independently disposed from the continuous part 40U. The two independent parts 41U are disposed on both outer sides of the continuous part 40U in the front and rear direction (both outer sides in the surface direction). The two independent parts 41U are disposed at positions including the right and left-direction central part (axis AY) of the upper surface 2U.

As shown in FIG. 16, the independent part 41U includes an independent part inner penetrating hole 410U, a deep bottom part 411U, and a shallow bottom part 412U. The shallow bottom part 412U is provided to be recessed on the upper surface 2U. As shown in FIG. 15, the shallow bottom part 412U exhibits a long hole shape extending in the right and left direction. The deep bottom part 411U is provided to be recessed on the bottom surface of the shallow bottom part 412U. The independent part inner penetrating hole 410U is provided open on the bottom surface of the deep bottom part 411U. The independent part inner penetrating hole 410U continues to the rear-side disposition part 4D. When the flow path cross-sectional areas are compared, the independent part inner penetrating hole 410U is the minimum, the deep bottom part 411U is intermediate, and the shallow bottom part 412U is the maximum.

As shown in FIG. 5, FIG. 11, FIG. 13, and FIG. 16, the continuous part 40U and the independent parts 41U communicate with each other through the continuous part inner penetrating holes 402Ua, the rear-side disposition part 4D, and the independent part inner penetrating holes 410U. As shown in FIG. 16, in the independent part 41U, the gasket 5 is disposed at the position of the upper surface 2U and below. That is, the gasket 5 is disposed so as not to protrude upward from the upper surface 2U.

### Rear-Side Disposition Part 4D

As shown in FIG. 7, the rear-side disposition part 4D is disposed on the lower surface 2D of the first separator 2. The rear-side disposition part 4D is disposed around the seven scaling target regions 22DLa, 22DLb, 22DLc, 22DRa, 22DRb, 22DRc, and 22DM.

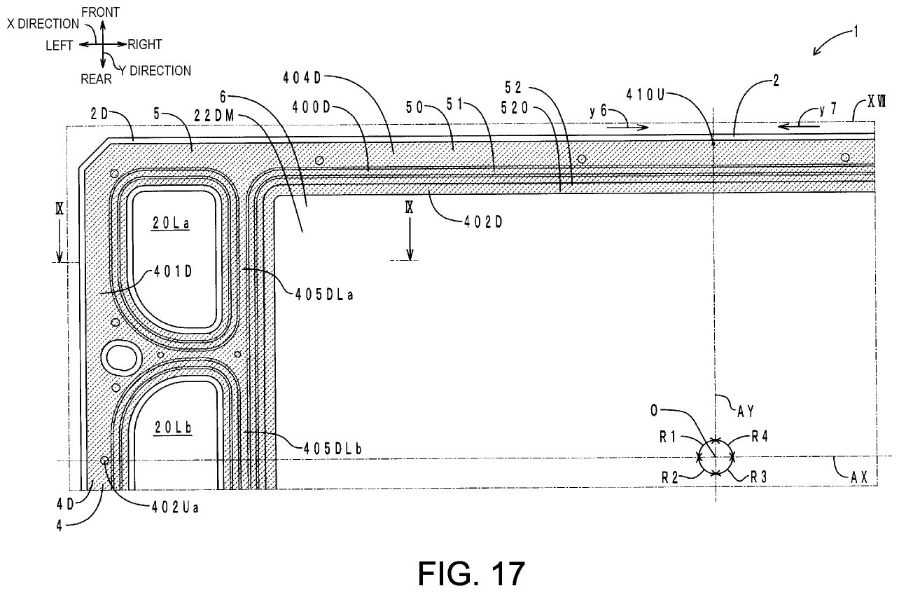

FIG. 17 shows an enlarged view of the inside of a frame XVII in FIG. 6. The gasket 5 is hatched with dotted lines. In addition, the first separator 2 is shown through the gasket 5. As shown in FIG. 7 and FIG. 17, the rear-side disposition part 4D includes a rear-side groove part 400D, a holding part fixation groove part 402D, a groove edge part 401D, a rear side outer frame part 404D, six rear-side interposition parts 405DLa, 405DLb, 405DLc, 405DRa, 405DRb, and 405DRc.

### Rear-Side Groove Part 400D

As shown in FIG. 9, the sealing lips 51 of the gasket 5 protrude from the rear-side groove part 400D downward relative to the lower surface 2D. As shown in FIG. 11, a groove bottom part of the rear-side groove part 400D is disposed on the upper side (at a deeper position) of the lower surface 2D (the disposition surface of the groove edge part 401D).

Similar to the front-side groove part 400U shown in FIG. 10, the groove width of the rear-side groove part 400D (the same as the groove width W2 of the front-side groove part 400U shown in FIG. 10) is narrower than the lip width of the sealing lip 51 (the same as the lip width W1 of the scaling lip 51 shown in FIG. 10). In a plan view (seen from below), the top parts 510 of the sealing lips 51 are disposed in the groove of the rear-side groove part 400D.

### Holding Part Fixation Groove Part 402D and Groove Edge Part 401D

As shown in FIG. 9, the holding part fixation groove part 402D is provided to be recessed on the lower surface 2D. As shown in FIG. 7 and FIG. 17, the holding part fixation groove part 402D is disposed along the outer edge of the sealing target region 22DM. As shown in FIG. 9, the groove edge part 401D is disposed flush with the lower surface 2D. That is, the groove edge part 401D continues to the lower surface 2D with no level differences therebetween. The groove edge part 401D stretches from the rear-side groove part 400D outward in the surface direction. The groove edge part 401D extends up to near the outer edge of the lower surface 2D.

### Rear Side Outer Frame Part 404D and Rear-Side Interposition Parts 405DLa, 405DLb, 405DLc, 405DRa, 405DRb, and 405DRc

As shown in FIG. 7, the rear side outer frame part 404D extends in a rectangular frame shape along the outer edge of the lower surface 2D. In the rear side outer frame part 404D, the rear-side groove part 400D is disposed along the extension direction of the rear side outer frame part 404D. In addition, in the rear side outer frame part 404D, the groove edge part 401D is disposed to protrude from the rear-side groove part 400D of the rear side outer frame part 404D.

Among the six rear-side interposition parts 405DLa, 405DLb, 405DLc, 405DRa, 405DRb, and 405DRc, four rear-side interposition parts 405DLa, 405DLc, 405DRa, and 405DRc are disposed in the four regions R1 to R4 one by one. The four rear-side interposition parts 405DLa, 405DLc, 405DRa, and 405DRc are each disposed in an L shape on the inside in the surface direction of the four corners of the rear side outer frame part 404D. Specifically, the rear-side interposition part 405DLa is disposed between the sealing target region 22DLa and the scaling target region 22DLb and the sealing target region 22DM. The rear-side interposition part 405DLc is disposed between the sealing target region 22DLc and the sealing target region 22DLb and the sealing target region 22DM. The rear-side interposition part 405DRa is disposed between the sealing target region 22DRa and the sealing target region 22DRb and the sealing target region 22DM. The rear-side interposition part 405DRc is disposed between the sealing target region 22DRc and the sealing target region 22DRb and the sealing target region 22DM.

Between the remaining rear-side interposition parts 405DLb and 405DRb, the rear-side interposition part 405DLb connects the L-like corner part of the rear-side interposition part 405DLa and the L-like corner part of the rear-side interposition part 405DLc. In addition, the rear-side interposition part 405DRb connects the L-like corner part of the rear-side interposition part 405DRa and the L-like corner part of the rear-side interposition part 405DRc.

The rear-side interposition part 405DLb is disposed between the sealing target region 22DLb and the sealing target region 22DM. In addition, the rear-side interposition part 405DRb is disposed between the sealing target region 22DRb and the sealing target region 22DM.

Like the front-side interposition part 405ULa, the rear-side interposition parts 405DLa, 405DLb, 405DLc, 405DRa, 405DRb, and 405DRc are each interposed between two rear-side groove parts 400D adjacent to each other in the surface direction.

### Gasket 5

As shown in FIG. 4, FIG. 6, FIG. 8, FIG. 11, and FIG. 17, the gasket 5 is integrally molded with the gasket disposition part 4 of the first separator 2. The gasket 5 is one continuous body. The gasket 5 includes base parts 50, the sealing lips 51, and MEGA holding parts 52.

As shown in FIG. 8, on the upper surface 2U, the base parts 50 are disposed in the plurality of side protrusion parts 401U of the front side outer frame part 404U and the four front-side interposition parts 405ULa, 405ULc, 405URa, and 405URc. As shown in FIG. 11, the top surface (upper surface) of the base part 50 is flush with the upper surface 2U. That is, the base parts 50 are buried in the upper surface 2U.

As shown in FIG. 17, on the lower surface 2D, the base parts 50 are disposed in the groove edge part 401D of the rear side outer frame part 404D and the six rear-side interposition parts 405DLa, 405DLb, 405DLc, 405DRa, 405DRb, and 405DRc. As shown in FIG. 11, the top surface (lower surface) of the base part 50 is disposed on the lower side of the lower surface 2D through a level difference. That is, the base parts 50 are laminated on the lower surface 2D.

As shown in FIG. 8, FIG. 11, and FIG. 17, the sealing lips 51 are disposed along the front-side groove part 400U and the rear-side groove part 400D. The sealing lip 51 includes the top part 510 and a hem part 511. The top part 510 is the protrusion end of the sealing lip 51. The top part 510 is elastically in contact with the second separator 7, which will be described below. The clastic contact makes the top parts 510 form a sealing line (a linear sealing part or a band sealing part). The hem part 511 is disposed on the groove-width-direction outer side of the top part 510. The hem part 511 exhibits a slope shape. The hem part 511 connects the base part 50 and the top part 510.

As shown in FIG. 6 and FIG. 17, the MEGA holding part 52 is disposed around the sealing target region 22DM along the holding part fixation groove part 402D of the lower surface 2D. The MEGA holding part 52 extends in a rectangular frame shape. As shown in FIG. 9, the MEGA holding part 52 includes a pair of upper and lower gripping bodies 520.

### MEGA 6

As shown in FIG. 6 and FIG. 17, MEGA 6 has a rectangular thin plate shape and is disposed on the lower surface 2D. As shown in FIG. 9, the outer edge of MEGA 6 is held in the vertical direction by the pair of gripping bodies 520 in the MEGA holding parts 52 of the gasket 5. That is, the gasket 5 is integrally molded with the first separator 2 and MEGA 6.

MEGA 6 includes a membrane electrode assembly (MEA), which is not shown, and a pair of gas diffusion layers. The pair of gas diffusion layers are laminated on both (upper and lower) surfaces of MEA. MEA includes an electrolyte film and a pair of catalyst layers. The pair of catalyst layers are laminated on both (upper and lower) surfaces of the electrolyte film.

### Second Separator 7

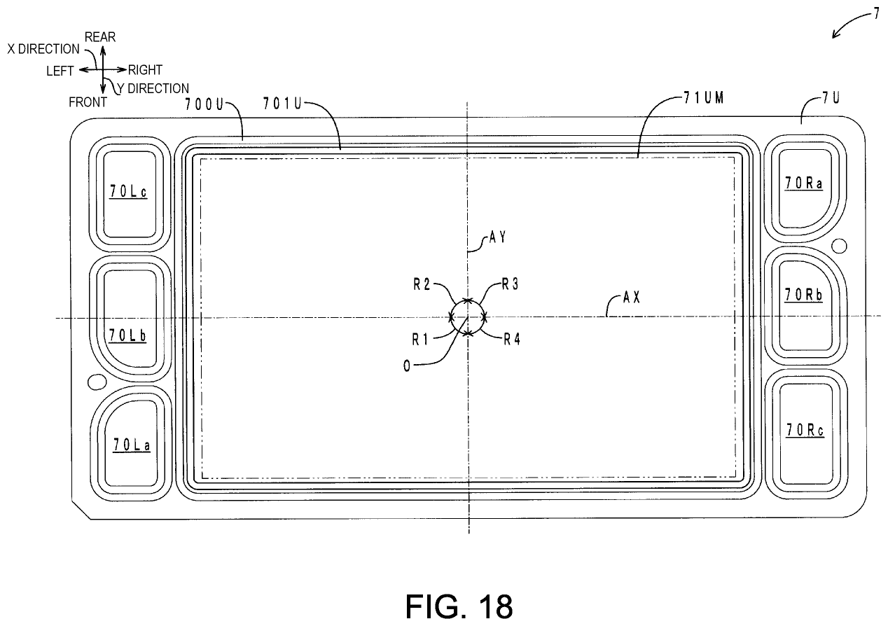

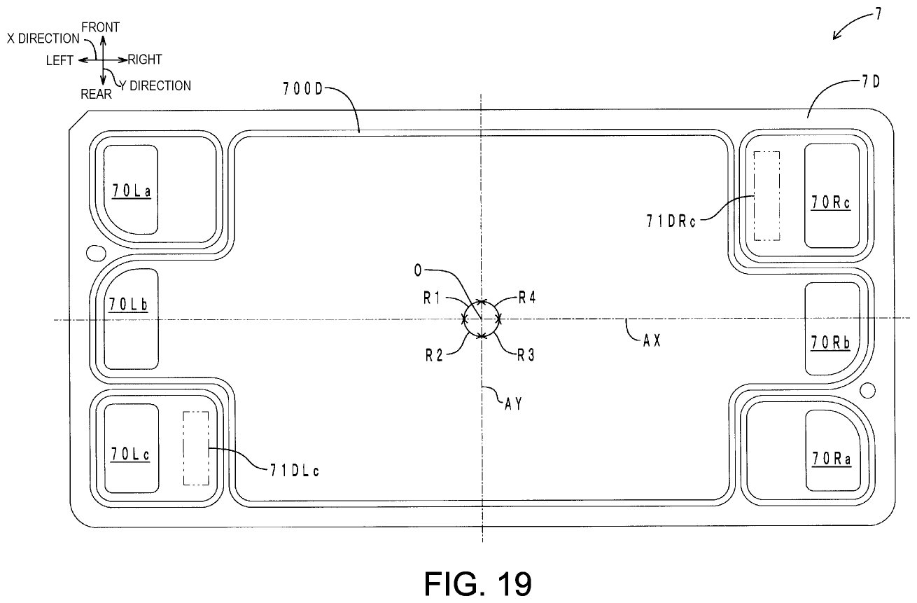

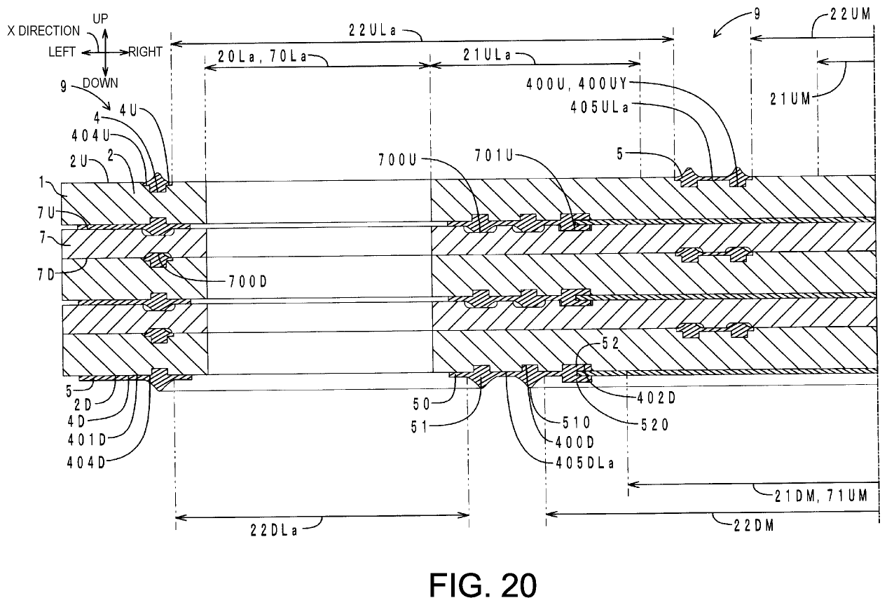

Next, the configuration of the second separator of the present embodiment will be described. FIG. 18 shows a top view of the second separator of the present embodiment. FIG. 19 shows a bottom view of the same second separator. FIG. 20 shows a vertical-direction partial cross-sectional view of the stack shown in FIG. 1. FIG. 20 corresponds to an IX-IX cross section of FIG. 8 (refer to FIG. 9).

As shown in FIG. 1 to FIG. 3, FIG. 18, and FIG. 19, the second separator 7 is, similar to the first separator 2, made of a conductive resin and exhibits a rectangular thin plate shape. The second separator 7 includes six manifolds 70La to 70Lc and 70Ra to 70Rc. The six manifolds 70La to 70Lc and 70Ra to 70Rc continue with the six manifolds 20La to 20Lc and 20Ra to 20Rc of the first separator 2 in the vertical direction.

As shown in FIG. 18, on the upper surface 7U of the second separator 7, the front-side groove part 700U, the holding part accommodation groove part 701U, and a flow path region 71UM indicated by a dashed-two dotted line are disposed. As shown in FIG. 3, FIG. 7, and FIG. 20, the front-side groove part 700U faces the rear-side groove part 400D of the lower surface 2D of the first separator 2. The top parts 510 of the sealing lips 51 of the gasket 5 disposed in the rear-side groove part 400D are elastically in contact with the groove bottom surface of the front-side groove part 700U. The elastic contact makes sealing lines formed. As shown in FIG. 3, FIG. 7, and FIG. 20, the holding part accommodation groove part 701U faces the holding part fixation groove part 402D. The gripping bodies 520 of the MEGA holding parts 52 of the gasket 5 disposed in the holding part fixation groove part 402D are elastically in contact with the holding part accommodation groove part 701U. The elastic contact brings the MEGA holding parts 52 into contact with MEGA 6 by pressure. In addition, the elastic contact makes a sealing line formed. As described above, around MEGA 6, annular outer sealing lines formed by the top parts 510 of the sealing lips 51 and an annular inner sealing line formed by the gripping bodies 520 are disposed. In addition, between the upper surface 7U and the lower surface 2D, the gasket 5 in the groove edge part 401D is interposed as a whole except MEGA 6. The surface of the gasket 5 in the groove edge part 401D is in contact with the upper surface 7U. Therefore, insulation between the upper surface 7U and the lower surface 2D can be ensured.

As shown in FIG. 19, on the lower surface 7D of the second separator 7, the rear-side groove part 700D and flow path regions 71DLc and 71DRc indicated by dashed-two dotted lines arc disposed. As shown in FIG. 2, FIG. 5, and FIG. 20, the rear-side groove part 700D faces the front-side groove part 400U on the upper surface 2U of the first separator 2. The top parts 510 of the sealing lips 51 of the gasket 5 disposed in the front-side groove part 400U are elastically in contact with the groove bottom surface of the rear-side groove part 700D. The elastic contact makes sealing lines formed. On the other hand, the lower surface 7D is in contact with the upper surface 2U as a whole. Therefore, conduction between the lower surface 7D and the upper surface 2U can be ensured.

### Method for Manufacturing Fuel Cell Composite Member

Next, a method for manufacturing a fuel cell composite member of the present embodiment will be described. The method for manufacturing a fuel cell composite member of the present embodiment has a disposition step, a raw material injection step, and a mold opening step.

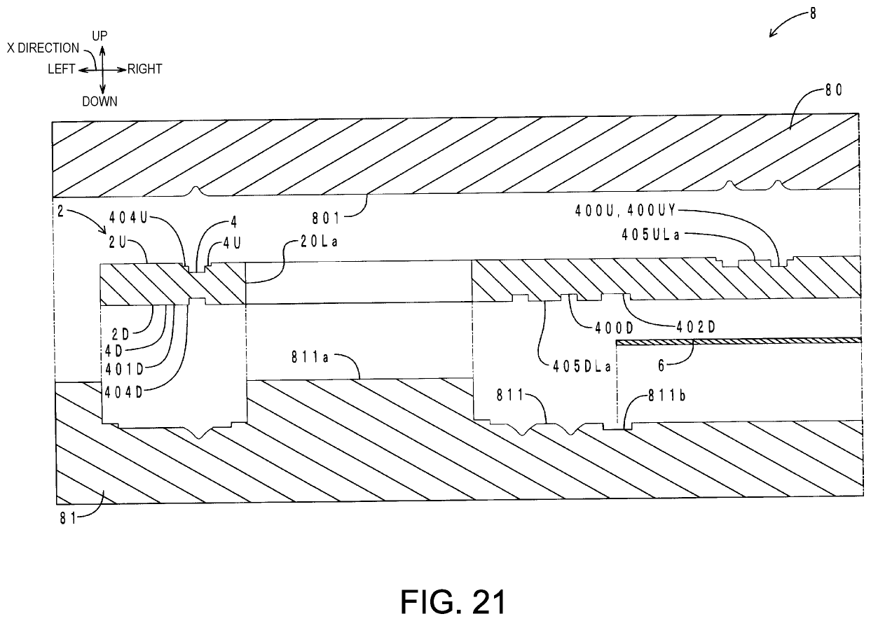

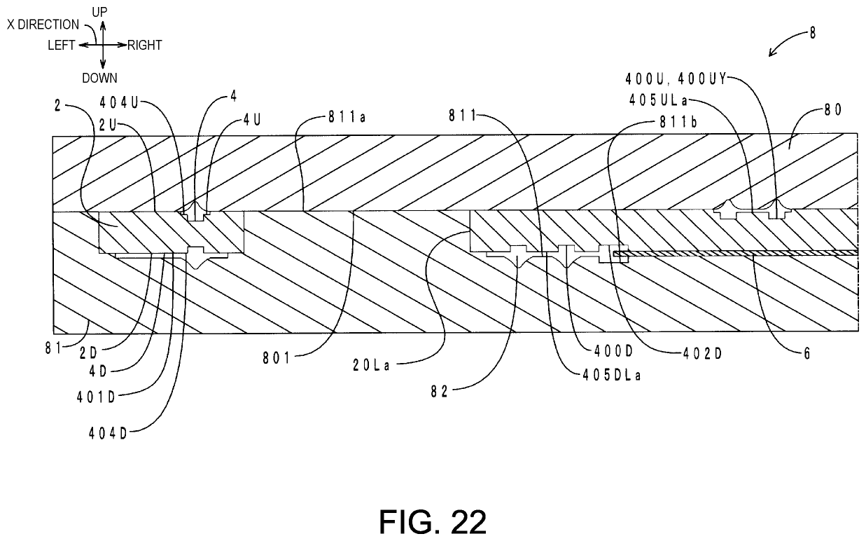

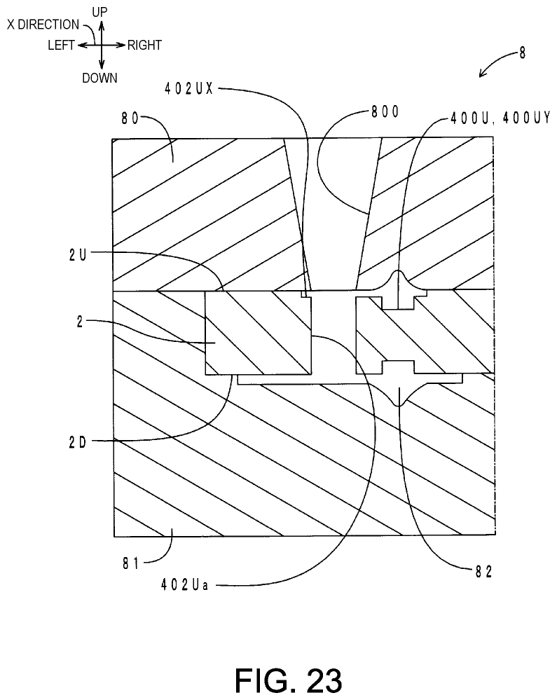

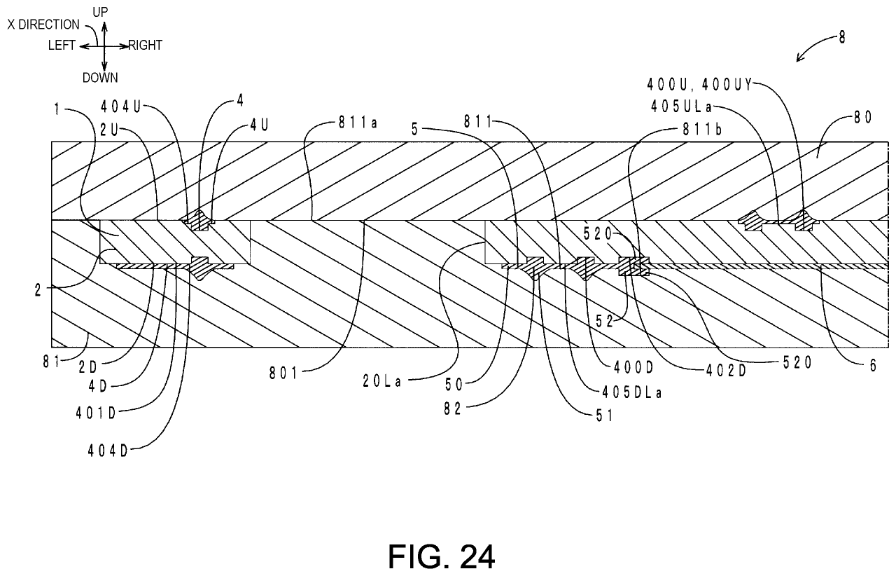

FIG. 21 shows a schematic view (near the front left manifold of the first separator) of a first stage of the disposition step of the method for manufacturing a fuel cell composite member of the present embodiment. FIG. 22 shows a schematic view (near the front left manifold of the first separator) of a second stage of the same step. FIG. 23 shows a schematic view (near the X-direction outer-end-side protrusion part on the left side of the first separator) of the same stage. FIG. 24 shows a schematic view of the raw material injection step of the same manufacturing method. FIG. 21, FIG. 22, and FIG. 24 corresponds to the IX-IX cross section of FIG. 8 (refer to FIG. 9). FIG. 23 corresponds to a cross sectional in the XI-XI direction of FIG. 10 (refer to FIG. 11).

### Mold

First, the configuration of a mold 8 that is used in the method for manufacturing a fuel cell composite member of the present embodiment will be described. As shown in FIG. 21, the mold 8 includes a first mold 80 and a second mold 81. The first mold 80 can be brought away from and into contact with the second mold 81 from above. The shape of the gasket 5 that is integrally molded with the front-side disposition part 4U of the first separator 2 is imparted to a molding surface 801 of the first mold 80. The shape of the gasket 5 that is integrally molded with the rear-side disposition part 4D of the first separator 2 is imparted to a molding surface 811 of the second mold 81. In addition, on the molding surface 811, six bosses 811a are disposed to correspond to the six manifolds 20La to 20Lc and 20Ra to 20Rc of the first separator 2 (refer to FIG. 5). In addition, on the molding surface 811, holding part molding groove parts 811b having a rectangular frame shape are disposed. As shown in FIG. 22, in a closed mold state, a cavity 82 having the same shape as the gasket 5 is formed in the mold 8. As shown in FIG. 23, the first mold 80 includes gates 800. Two gates 800 are disposed right and left to correspond to the two X-direction outer-end-side protrusion parts 402UX disposed right and left in the first separator 2 shown in FIG. 5.

### Disposition Step

In the present step, MEGA 6 and the first separator 2 are disposed in the second mold 81 of the mold 8 in an open mold state. As shown in FIG. 21, first, MEGA 6 is disposed on the molding surface 811 of the second mold 81. Next, the first separator 2 is disposed on the upper side of MEGA 6. At this time, the six bosses 811a on the molding surface 811 are relatively inserted into the six manifolds 20La to 20Lc and 20Ra to 20Rc (refer to FIG. 5) of the first separator 2.

Subsequently, as shown in FIG. 22, the first mold 80 is brought into contact with the second mold 81 from above. That is, the mold is closed. As shown in FIG. 23, the mold closing makes the gate 800 disposed immediately above the X-direction outer-end-side protrusion part 402UX of the first separator 2. That is, the gate 800 faces the continuous part 40U of the front-side disposition part 4U.

### Raw Material Injection Step

In the present step, a raw material of the gasket (specifically, liquid-form silicone rubber) is injected into the cavity 82 (the positions immediately above the X-direction outer-end-side protrusion parts 402UX) from the two gates 800. As shown by arrows y1 to y4 in FIG. 8, in the front-side disposition part 4U in the region R1, the raw material flows between the X-direction outer-end-side protrusion part 402UX and the Y-direction outer-end-side protrusion part 402UY through the branching and merging sections A. Specifically, the raw material flows from the upstream side toward the downstream side in the order of the X-direction outer-end-side protrusion part 402UX→the upstream trunk part A1→the branching part A4→the outer circumferential branch part A3a and the inner circumferential branch part A3b→the merging part A5→the downstream trunk part A2→the Y-direction outer-end-side protrusion part 402UY. This is also true for the regions R2 to R4.

As shown in FIG. 5 and FIG. 8, the raw material from the region R1 (the arrows y1 to y4 in FIG. 8) and the raw material from the region R4 (an arrow y5 in FIG. 8) merge in the Y-direction outer-end-side protrusion part 402UY on the front side. Similarly, the raw material from the region R2 and the raw material from the region R3 merge in the Y-direction outer-end-side protrusion part 402UY on the rear side.

When the raw material flows into the X-direction outer-end-side protrusion parts 402UX from the gates 800, the raw material flows into the rear-side disposition part 4D through the continuous part inner penetrating holes 402Ua in the X-direction outer-end-side protrusion parts 402UX. In addition, when the raw material passes through the penetrating side protrusion parts 402U other than the X-direction outer-end-side protrusion parts 402UX, the raw material flows into the rear-side disposition part 4D through the continuous part inner penetrating holes 402Ua. In addition, after the raw material merges in the Y-direction outer-end-side protrusion part 402UY, the raw material flows into the rear-side disposition part 4D through the two continuous part inner penetrating holes 402Ua in the Y-direction outer-end-side protrusion parts 402UY. In addition, when the raw material passes through the front-side interposition part 405ULa, the raw material flows into the rear-side disposition part 4D through the continuous part inner penetrating holes 402Ua in the front-side interposition part 405ULa. As described above, the raw material flows into the rear-side disposition part 4D from each place in the front-side disposition part 4U through the plurality of continuous part inner penetrating holes 402Ua.

As shown by an arrow y6 in FIG. 17, in the rear-side disposition part 4D in the region R1, the raw material diffuses on the lower surface 2D in the surface direction along the shape of the cavity 82 (refer to FIG. 24) from the plurality of continuous part inner penetrating holes 402Ua. The raw material that has spread up to the corners of the rear-side disposition part 4D merges in the independent part inner penetrating holes 410U. The raw material that has merged flows into the independent part 41U shown in FIG. 8 (the deep bottom part 411U and the shallow bottom part 412U) through the independent part inner penetrating holes 410U. This is also true for the regions R2 to R4.

As shown in FIG. 7 and FIG. 17, the raw material from the region R1 (the arrow y6 in FIG. 17) and the raw material from the region R4 (an arrow y7 in FIG. 17) merge in the independent part inner penetrating holes 410U on the front side. As shown in FIG. 16, the raw material that has merged (an arrow y8 in FIG. 16) flows into the independent parts 41U from below. Similarly, the raw material from the region R2 and the raw material from the region R3 merge in the independent part inner penetrating holes 410U on the rear side and flow into the independent parts 41U on the rear side.

The raw material spreads the entire cavity 82 in the above-described manner. As shown in FIG. 24, the raw material cures in the cavity 82, whereby the gasket 5 is molded. At this time, the gasket 5 is integrated with the first separator 2 and MEGA 6. The fuel cell composite member 1 is produced in the above-described manner.

### Mold Opening Step

In the present step, the first mold 80 is separated from the second mold 81. That is, the mold is opened. In addition, the fuel cell composite member 1 is removed from the cavity 82. After that, the fuel cell composite members 1 and the second separators 7 are alternately laminated as shown in FIG. 1 to form a laminate, and the laminate is clamped with the pair of end plates 90, whereby the stack 9 is assembled.

### Action and Effect

Next, the action and effect of the fuel cell composite member of the present embodiment and the manufacturing method therefor will be described. As shown in FIG. 4, FIG. 6, and FIG. 24, the gasket 5 is integrally molded with the gasket disposition part 4 of the first separator 2. Therefore, it is possible to reduce the man-hours compared with a method in which a separate gasket 5 produced in advance is attached to the first separator 2. In addition, it is possible to determine the positions of the gasket 5 and the first separator 2 and integrate the gasket and the first separator at the same time as the molding of the gasket 5.

As shown in FIG. 5, the first separator 2 has the continuous part inner penetrating holes 402Ua and the independent part inner penetrating holes 410U. Therefore, it is possible to increase the contact area between the first separator 2 and the gasket 5. Therefore, it is possible to suppress the deviation or dropping off of the gasket 5 from the first separator 2 in spite of the fact that the gasket is not attached to the first separator. In addition, as shown in FIG. 11 and FIG. 16, the gasket 5 is integrally molded with the upper and lower (both) surfaces (front and rear surfaces) of the first separator 2 through the continuous part inner penetrating holes 402Ua and the independent part inner penetrating holes 410U. Therefore, it is possible to suppress the deviation or dropping off of the gasket 5 from the first separator 2 due to an anchoring effect in spite of the fact that the gasket is not attached to the first separator. In addition, it is possible to determine the positions of the gasket 5 and the first separator 2 and integrate the gasket and the first separator at the same time as the molding of the gasket 5. As an example, the anchoring effect that the gasket 5 in the front-side disposition part 4U enjoys will be described. The gasket 5 in the front-side disposition part 4U is connected with the gasket 5 in the rear-side disposition part 4D through the continuous part inner penetrating holes 402Ua and the independent part inner penetrating holes 410U (the gasket 5 is one body). Therefore, when an attempt is made to drop the gasket 5 off from the front-side disposition part 4U, the gasket 5 in the rear-side disposition part 4D functions like the “barb” of a hook and suppresses the drop. This is also true for an anchoring effect that the gasket 5 in the rear-side disposition part 4D enjoys. In the case of the gasket 5 in the rear-side disposition part 4D, the gasket 5 in the front-side disposition part 4U functions like the “barb” of a hook.

As shown in FIG. 5 and FIG. 14, the independent parts 41U are independent from the continuous part 40U, that is, the sealing target regions 22ULa, 22ULc, 22URa, 22URc, and 22UM. In addition, the independent parts 41U are disposed on the outer sides of the continuous part 40U in the front and rear direction (in the surface direction). Therefore, even in a case where a molding defect (a burr or the like) is generated in the gasket 5 in the independent part 41U, in other words, in a case where the shape accuracy of the gasket 5 in the independent part 41U is low, the shape accuracy is less likely to affect the gasket 5 in the continuous part 40U. Therefore, it is possible to suppress the deterioration of sealing properties attributed to the gasket 5 in the independent parts 41U.

As shown in FIG. 16, in the independent part 41U, the gasket 5 is disposed so as not to protrude upward from the upper surface 2U of the first separator 2. Therefore, even in a case where a molding defect (a burr or the like) is generated in the gasket 5 in the independent part 41U, it is possible to suppress the deterioration of sealing properties attributed to the gasket 5 in the independent parts 41U.

As shown in FIG. 5, the first separator 2 includes the front-side groove part 400U, the penetrating side protrusion parts 402U, the continuous part inner penetrating holes 402Ua, the non-penetrating side protrusion parts 403U, and the continuous part inner non-penetrating holes 403Ua. Therefore, it is possible to increase the contact area between the first separator 2 and the gasket 5. Therefore, it is possible to suppress the deviation or dropping off of the gasket 5 from the first separator 2 in spite of the fact that the gasket is not attached to the first separator.

As shown in FIG. 11, in the upper side of the front-side groove part 400U, the sealing lip 51 of the gasket 5 (in detail, the top part 510 of the sealing lip 51 that forms a sealing line) is disposed. On the other hand, as shown in FIG. 12, the continuous part inner penetrating hole 402Ua is disposed in the penetrating side protrusion part 402U, and the continuous part inner non-penetrating hole 403Ua is disposed in the non-penetrating side protrusion part 403U, respectively. That is, the continuous part inner penetrating holes 402Ua and the continuous part inner non-penetrating holes 403Ua are not disposed in the front-side groove part 400U. Therefore, even in a case where a molding defect (a sink mark or the like) is generated due to the gasket 5 in the continuous part inner penetrating hole 402Ua or the continuous part inner non-penetrating hole 403Ua, the molding defect is less likely to affect the gasket 5 in the front-side groove part 400U. Therefore, it is possible to suppress the deterioration of sealing properties attributed to the gasket 5 in the continuous part inner penetrating hole 402Ua or the continuous part inner non-penetrating hole 403Ua.

As shown in FIG. 5, the two independent parts 41U are disposed at positions including an axis AY on the upper surface 2U. In addition, the two independent parts 41U are disposed on both outer sides of the plurality of X-direction extension parts 400UX in the front and rear direction. In addition, as shown in FIG. 15 and FIG. 16, the independent part inner penetrating hole 410U is disposed in the independent part 41U. Therefore, it is possible to suppress the deviation or dropping off of the gasket 5 from the first separator 2 at the positions including the axis AY on the upper surface 2U and on both outer sides of the front-side groove part 400U in the front and rear direction.

As shown in FIG. 5, the two X-direction outer-end-side protrusion parts 402UX are disposed at positions including an axis AX of the upper surface 2U. In addition, the two X-direction outer-end-side protrusion parts 402UX are disposed on both outer sides of the plurality of Y-direction extension parts 400UY in the right and left direction. In addition, as shown in FIG. 10 and FIG. 11, the continuous part inner penetrating hole 402Ua is disposed in the X-direction outer-end-side protrusion part 402UX. Therefore, it is possible to suppress the deviation or dropping off of the gasket 5 from the first separator 2 at the positions including the axis AX on the upper surface 2U and on both outer sides of the front-side groove part 400U in the right and left direction.

As shown in FIG. 5, the two Y-direction outer-end-side protrusion parts 402UY are disposed at positions including an axis AY on the upper surface 2U. In addition, the two Y-direction outer-end-side protrusion part 402UY are disposed on both outer sides of the plurality of X-direction extension parts 400UX in the front and rear direction. In addition, as shown in FIG. 14, the pair of right and left continuous part inner penetrating holes 402Ua are disposed in the Y-direction outer-end-side protrusion part 402UY. Therefore, it is possible to suppress the deviation or dropping off of the gasket 5 from the first separator 2 at the positions including the axis AY on the upper surface 2U and on both outer sides of the front-side groove part 400U in the front and rear direction.

As shown in FIG. 5 and FIG. 8, the front-side interposition parts 405ULa, 405ULc, 405URa, and 405URc have the continuous part inner penetrating holes 402Ua and the continuous part inner non-penetrating holes 403Ua. Therefore, it is possible to increase the contact area between the front-side interposition parts 405ULa, 405ULc, 405URa, and 405URc and the gasket 5. Therefore, it is possible to suppress the deviation or dropping off of the gasket 5 from the front-side interposition parts 405ULa, 405ULc, 405URa, and 405URc in spite of the fact that the gasket is not attached to the front-side interposition parts. In addition, the gasket 5 is integrally molded with the upper and lower (both) surfaces of the first separator 2 through the continuous part inner penetrating holes 402Ua. Therefore, it is possible to suppress the deviation or dropping off of the gasket 5 from the front-side interposition parts 405ULa, 405ULc, 405URa, and 405URc due to an anchoring effect in spite of the fact that the gasket is not attached to the front-side interposition parts.

As shown in FIG. 8, the merging-part side protrusion part 402UA is disposed in the merging part A5. Therefore, it is possible to increase the contact area between the merging part A5 and the gasket 5. In addition, the gasket 5 is integrally molded with the upper and lower (both) surfaces of the first separator 2 through the continuous part inner penetrating holes 402Ua of the merging-part side protrusion part 402UA. Therefore, it is possible to suppress the deviation or dropping off of the gasket 5 from the merging part A5 due to an anchoring effect. In addition, the non-penetrating side protrusion part 403U is disposed in the outer circumferential branch part A3a. Therefore, it is possible to increase the contact area between the outer circumferential branch parts A3a and the gasket 5.

As shown in FIG. 10, the continuous part inner penetrating hole 402Ua is disposed at the groove-width-direction outer end of the penetrating side protrusion part 402U. That is, in the penetrating side protrusion part 402U, the continuous part inner penetrating hole 402Ua is disposed at the position most separated from the front-side groove part 400U. Therefore, even in a case where the shape accuracy of the gasket 5 in the continuous part inner penetrating hole 402Ua is low, the shape accuracy is less likely to affect the gasket 5 in the front-side groove part 400U. Therefore, it is possible to suppress the deterioration of sealing properties attributed to the gasket 5 in the continuous part inner penetrating hole 402Ua.

As shown in FIG. 12, the continuous part inner non-penetrating hole 403Ua is disposed at the groove-width-direction outer end of the non-penetrating side protrusion part 403U. That is, in the non-penetrating side protrusion part 403U, the continuous part inner non-penetrating hole 403Ua is disposed at the position most separated from the front-side groove part 400U. Therefore, even in a case where the shape accuracy of the gasket 5 in the continuous part inner non-penetrating hole 403Ua is low, the shape accuracy is less likely to affect the gasket 5 in the front-side groove part 400U. Therefore, it is possible to suppress the deterioration of sealing properties attributed to the gasket 5 in the continuous part inner non-penetrating hole 403Ua.

As shown in FIG. 4 and FIG. 6, the gasket 5 in the front-side disposition part 4U exhibits a thin string shape with respect to the gasket 5 in the rear-side disposition part 4D. In addition, the gasket 5 is rubber-elastic and flexible. Therefore, in the mold opening step, the gasket 5 in the front-side disposition part 4U is less likely to be released from the molding surface 801 of the first mold 80 shown in FIG. 24. That is, the mold releasability is low. Regarding this point, the plurality of side protrusion parts 401U (the penetrating side protrusion parts 402U and the non-penetrating side protrusion parts 403U) is disposed in the front-side disposition part 4U. Therefore, it is possible to improve the mold releasability of the gasket 5 from the molding surface 801.

As shown in FIG. 5, all of the side protrusion parts 401U are disposed in the front side outer frame part 404U. Therefore, compared with a case where the side protrusion parts 401U are disposed in the front-side interposition parts 405ULa, 405ULc, 405URa, and 405URc, it is possible to widen the flow path regions 21ULa, 21ULc, 21URa, 21URc, and 21UM.

As shown in FIG. 5, all of the side protrusion parts 401U overhang outward in the surface direction from the front-side groove part 400U of the front side outer frame part 404U. Therefore, compared with a case where the side protrusion parts 401U overhang inward in the surface direction from the front-side groove part 400U of the front side outer frame part 404U, it is possible to widen the flow path regions 21ULa, 21ULc, 21URa, 21URc, and 21UM.

As shown in FIG. 7, FIG. 9, and FIG. 17, the rear-side disposition part 4D includes the groove edge part 401D that is flush with the lower surface 2D of the first separator 2. Therefore, the gasket 5 in the groove edge part 401D makes it possible to dispose a surface sealing part (planar sealing part) on the lower surface 2D. Specifically, as shown in FIG. 20, it is possible to form a surface sealing part having a wide area and a frame shape between the outer edge of the lower surface 2D of the first separator 2 and the outer edge of the upper surface 7U of the second separator 7. In the surface sealing part, the surface of the gasket 5 is wholly in contact with the upper surface 7U.

As shown in FIG. 7 and FIG. 17, in the rear-side disposition part 4D, the continuous part inner penetrating holes 402Ua in the front-side disposition part 4U are opened. Therefore, it is possible to increase the contact area between the first separator 2 and the gasket 5. In addition, it is possible to suppress the deviation or dropping off of the gasket 5 from the rear-side disposition part 4D due to an anchoring effect in spite of the fact that the gasket is not attached to the first separator. Particularly, in the rear-side interposition parts 405DLa, 405DLb, 405DLc, 405DRa, 405DRb, and 405DRc, the continuous part inner penetrating holes 402Ua in the front-side interposition parts 405ULa, 405ULc, 405URa, and 405URc are opened. Therefore, it is possible to increase the contact area between the first separator 2 and the gasket 5 between the front-side interposition parts 405ULa, 405ULc, 405URa, and 405URc and the rear-side interposition parts 405DLa, 405DLb, 405DLc, 405DRa, 405DRb, and 405DRc. In addition, it is possible to suppress the deviation or dropping off of the gasket 5 from the rear-side interposition parts 405DLa, 405DLb, 405DLc, 405DRa, 405DRb, and 405DRc due to an anchoring effect in spite of the fact that the gasket is not attached to the first separator.

As shown in FIG. 10, FIG. 11, and FIG. 15 to FIG. 17, in the raw material injection step, when the gasket 5 is integrally molded with the rear-side disposition part 4D, the raw material of the gasket 5 flows from the front-side disposition part 4U to the rear-side disposition part 4D through the plurality of continuous part inner penetrating holes 402Ua. The raw material that has flown into the rear-side disposition part 4D arrives at the independent part 41U (the deep bottom part 411U and the shallow bottom part 412U) in the end through the independent part inner penetrating hole 410U. Therefore, it is possible to collect a molding defect attributed to the flow (a void, slag, a short shot, or the like) in the independent part 41U. Therefore, it is possible to suppress the generation of a molding defect in the rear-side disposition part 4D.

As shown in FIG. 23, when the gasket 5 is integrally molded with the rear-side disposition part 4D, the raw material of the gasket 5 flows into the continuous part inner penetrating hole 402Ua through the penetrating side protrusion part 402U. Since the raw material flows through the penetrating side protrusion part 402U, it is possible to suppress the entrainment of an air when the raw material flows into the continuous part inner penetrating hole 402Ua. Therefore, it is possible to suppress the generation of a molding defect (a void or the like) in the rear-side disposition part 4D.

As shown in FIG. 10, FIG. 11, and FIG. 15 to FIG. 17, in the raw material injection step, when the gasket 5 is integrally molded with the rear-side disposition part 4D, the raw material of the gasket 5 flows from the two X-direction outer-end-side protrusion parts 402UX up to the two independent parts 41U through the rear-side disposition part 4D.

As shown in FIG. 5, the two independent parts 41U are disposed on positions including the axis AY that are both outer sides of the plurality of X-direction extension parts 400UX in the front and rear direction. In addition, the two X-direction outer-end-side protrusion parts 402UX are disposed on positions including the axis AX that are both outer sides of the plurality of Y-direction extension parts 400UY in the right and left direction. As described above, in a plan view, the two independent parts 41U and the two X-direction outer-end-side protrusion part 402UX are evenly disposed at intervals of 90° in terms of a central angle (a central angle around the intersection point O) near the outer edge of the upper surface 2U. Therefore, it is possible to suppress a variation in flow path length when the raw material of the gasket 5 flows. Therefore, it is possible to suppress the generation of a molding defect (a weld line or the like) attributed to the variation.

As shown in FIG. 8 and FIG. 23, in the raw material injection step, the raw material of the gasket 5 flows from the two X-direction outer-end-side protrusion parts 402UX up to the two Y-direction outer-end-side protrusion parts 402UY through the front-side disposition part 4U. As shown in FIG. 5, the two Y-direction outer-end-side protrusion parts 402UY are disposed on positions including the axis AY that are both outer sides of the plurality of X-direction extension parts 400UX in the front and rear direction. In addition, the two X-direction outer-end-side protrusion parts 402UX are disposed on positions including the axis AX that are both outer sides of the plurality of Y-direction extension parts 400UY in the right and left direction. As described above, in a plan view, the two Y-direction outer-end-side protrusion parts 402UY and the two X-direction outer-end-side protrusion part 402UX are evenly disposed at intervals of 90° in terms of a central angle near the outer edge of the upper surface 2U. Therefore, it is possible to suppress a variation in flow path length when the raw material of the gasket 5 flows. Therefore, it is possible to suppress the generation of a molding defect (a weld line or the like) attributed to the variation.

As shown in FIG. 8, the Y-direction outer-end-side protrusion part 402UY protrudes toward the front side (the outer side in the surface direction) from the X-direction extension part 400UX and exhibits a band shape that is long in the right and left direction. Therefore, the flow path width of the continuous part 40U is extended in a section where the Y-direction outer-end-side protrusion part 402UY is disposed. Therefore, even in a case where there is a variation in flow path length when the raw material of the gasket 5 flows through the continuous part 40U, it is possible for the Y-direction outer-end-side protrusion parts 402UY to absorb the variation.

As shown in FIG. 8 and FIG. 12, in the raw material injection step, when the gasket 5 is integrally molded with the front-side disposition part 4U, the raw material of the gasket 5 flows through the branching and merging section A in a direction of “the X-direction outer-end-side protrusion part 402UX→the upstream trunk part A1→the branching part A4→the outer circumferential branch parts A3a and the inner circumferential branch part A3b→the merging part A5→the downstream trunk part A2→the Y-direction outer-end-side protrusion part 402UY.” Here, the shapes (the extension shape, cross-sectional shape, and the like of the flow path), flow path lengths, and the like of the outer circumferential branch part A3a and the inner circumferential branch part A3b are not constant. In a case where the non-penetrating side protrusion parts 403U are not disposed, the flow path resistance becomes smaller in the outer circumferential branch parts A3a than in the inner circumferential branch parts A3b. Therefore, the raw material of the gasket 5 that flows through the outer circumferential branch parts A3a arrives at the merging part A5 earlier than the raw material that flows through the inner circumferential branch parts A3b. Therefore, the flow of the raw material that has flowed through the inner circumferential branch parts A3b and arrived at the merging part A5 is impaired by the flow of the raw material that has flowed through the outer circumferential branch parts A3a, arrived at the merging part A5, and passed through the merging part A5.

Regarding this point, the non-penetrating side protrusion part 403U is disposed in the outer circumferential branch part A3a (upstream of the merging part A5). Therefore, it is possible to increase the flow path resistance of the outer circumferential branch parts A3a. That is, it is possible to slow the flow rate of the raw material. Therefore, it is possible to suppress a variation in timing of the raw material of the gasket 5 that flows through the outer circumferential branch parts A3a and the inner circumferential branch parts A3b merging in the merging part A5. Therefore, it is possible to suppress the generation of a molding defects (a weld line or the like) attributed to the variation in timing. In the case of increasing the flow path resistance of the inner circumferential branch part A3b, the non-penetrating side protrusion parts 403U is disposed in the inner circumferential branch parts A3b. As described above, when the non-penetrating side protrusion parts 403U are disposed in arbitrary branch parts (the outer circumferential branch parts A3a and the inner circumferential branch parts A3b), it is possible to suppress a variation in flow path resistance between the outer circumferential branch part A3a and the inner circumferential branch part A3b.

As shown in FIG. 8, in the raw material injection step, when the gasket 5 is integrally molded with the rear-side disposition part 4D, the raw material of the gasket 5 flows into the continuous part inner penetrating hole 402Ua through the penetrating side protrusion part 402U. The penetrating side protrusion parts 402U exhibits a tapered shape that becomes gradually narrower toward the groove-width-direction outer end. The continuous part inner penetrating hole 402Ua is disposed at the tapered top part of the penetrating side protrusion part 402U. Therefore, the raw material of the gasket 5 stays in the penetrating side protrusion parts 402U (flows from the hem parts (the groove-width-direction inner end) of the penetrating side protrusion parts 402U toward the taping top parts (the groove-width-direction outer end)) and then flows into the continuous part inner penetrating holes 402Ua through the penetrating side protrusion parts 402U. Therefore, it is possible to suppress the entrainment of an air. Therefore, it is possible to suppress the generation of a molding defects (a void or the like) in the rear-side disposition part 4D.

As shown in FIG. 8, in the raw material injection step, when the gasket 5 is integrally

molded with the front-side disposition part 4U, the raw material of the gasket 5 flows along the front-side groove part 400U. The penetrating side protrusion parts 402U exhibits a tapered shape that becomes gradually narrower toward the groove-width-direction outer end. Therefore, it is possible to partially adjust the flow path width of the raw material of the gasket 5 in the front-side disposition part 4U. This is also true for the non-penetrating side protrusion parts 403U. In addition, the continuous part inner non-penetrating holes 403Ua are disposed at the tapered top parts of the non-penetrating side protrusion parts 403U. Therefore, it is possible to partially adjust the flow path depth of the raw material of the gasket 5 in the front-side disposition part 4U.

As shown in FIG. 5 and FIG. 8, the front-side interposition parts 405ULa, 405ULc, 405URa, and 405URc each have the continuous part inner penetrating holes 402Ua and the continuous part inner non-penetrating holes 403Ua. Therefore, in the raw material injection step, it is possible to cause the raw material of the gasket 5 to flow from the front-side disposition part 4U toward the rear-side disposition part 4D through the continuous part inner penetrating holes 402Ua of the front-side interposition parts 405ULa, 405ULc, 405URa, and 405URc. In addition, it is possible to adjust the flow rate of the raw material that flows through the front-side interposition parts 405ULa, 405ULc, 405URa, and 405URc (that is, the inner circumferential branch part A3b) with the continuous part inner penetrating holes 402Ua and the continuous part inner non-penetrating holes 403Ua.

As shown in FIG. 23, in the disposition step, the gate 800 faces the X-direction outer-end-side protrusion part 402UX (the continuous part inner penetrating hole 402Ua). The gate 800 does not face the front-side groove part 400U. Therefore, it is possible to suppress a gate trace remaining in the gasket 5 (particularly, the sealing lip 51) in the front-side groove part 400U.

The raw material of the gasket 5 that is used in the raw material injection step is liquid-form silicone rubber. The liquid-form silicone rubber is poorly viscous and highly fluid. Therefore, it is possible to dispose and mold the gasket 5 at once in the gasket disposition part 4 (the front-side disposition part 4U and the rear-side disposition part 4D) that is set across the upper surface 2U and the lower surface 2D of the first separator 2. In addition, it is possible to suppress the breakage of the first separator 2 and MEGA 6 that are disposed in advance in the cavity 82.

As shown in FIG. 21, in the disposition step, MEGA 6 is disposed in the cavity 82 together with the first separator 2. Therefore, the gasket 5 can be integrally molded with the first separator 2 and MEGA 6.

As shown in FIG. 20, the flow path region 21DM of the first separator 2 on the lower surface 2D side (anode side) and the flow path region 71UM of the second separator 7 on the upper surface 7U side (cathode side) face each other in the vertical direction across MEGA 6. The flow path region 21DM communicates with the manifold 20La through the penetrating hole (not shown) and the flow path region 21ULa. In addition, the flow path region 21DM communicates with the manifold 20Ra through the penetrating hole (not shown) and the flow path region 21URa. An air (oxygen) is supplied to the flow path region 21DM. The flow path region 71UM communicates with the manifold 20Lc through the penetrating hole (not shown) and the flow path region 21ULc. In addition, the flow path region 71UM communicates with the manifold 20Rc through the penetrating hole (not shown) and the flow path region 21URc. Hydrogen is supplied to the flow path region 21DM. The flow path region 21UM communicates with the manifolds 20Lb and 20Rb. Cooling water is supplied to the flow path region 21UM. As described above, the stack 9 is mainly composed of only two kinds of members, such as the fuel cell composite member 1 and the second separator 7. According to the stack 9 of the present embodiment, the number of components becomes small.

### Second Embodiment

A difference between a fuel cell composite member of the present embodiment and a manufacturing method therefor and the fuel cell composite member of the first embodiment and the manufacturing method therefore is that MEGA is not integrated with the fuel cell composite member. Here, only the difference will be described.

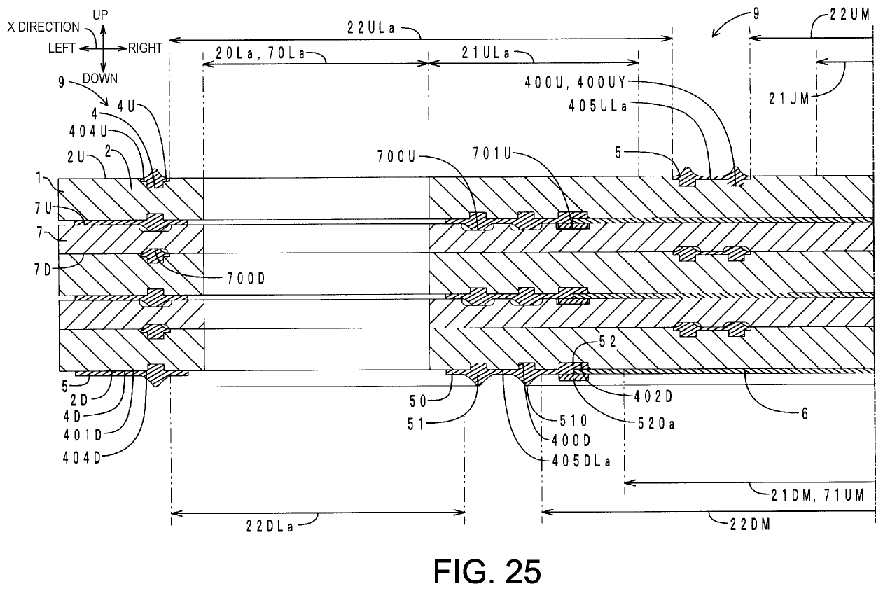

FIG. 25 shows a vertical-direction partial cross-sectional view of a stack of fuel cells including the fuel cell composite member of the present embodiment. The same reference sign will be given to parts corresponding to FIG. 20. As shown in FIG. 25, frame-like gripping pieces 520a are joined to the outer edge of MEGA 6. The gripping pieces 520a are made of, similar to the gasket 5. VMQ. The gripping piece 520a is one gripping body 520 (in detail, the gripping body 520 protruding downward from the lower surface 2D) of the pair of gripping bodies 520 of the MEGA holding part 52 in the gasket 5 shown in FIG. 9 that has been made into a separate body.

The method for manufacturing a fuel cell composite member 1 of the present embodiment has a joining step in addition to the disposition step, the raw material injection step, and the mold opening step. The method for manufacturing the fuel cell composite member 1 of the present embodiment will be described using FIG. 21 to FIG. 24 shown above. On the molding surface 811 of the second mold 81 of the mold 8, the holding part molding groove parts 811b are not provided to be recessed.

In the disposition step, the first separator 2 is disposed in the second mold 81 of the mold 8 in an open mold state as shown in FIG. 21, and the mold is closed as shown in FIG. 22. In the raw material injection step, the raw material of the gasket is injected into the cavity 82 (the position immediately above the X-direction outer-end-side protrusion part 402UX) from the two gates 800. The raw material spreads in the entire cavity 82 and cures. The gasket 5 is molded by the curing. At this time, the gasket 5 is integrated with the first separator 2. In the mold opening step, the mold is opened, and the first separator 2 with which the gasket 5 has been integrated is removed from the cavity 82. In the joining step, MEGA 6 is disposed on the inside of the MEGA holding part 52 of the gasket 5 in the surface direction, and the gripping pieces 520a are joined to the MEGA holding part 52. At this time, the outer edge of MEGA 6 is covered from below with the gripping pieces 520a. After that, the fuel cell composite members 1 and the second separators 7 are alternately laminated as shown in FIG. 1 to form a laminate, and the laminate is clamped with the pair of end plates 90, whereby the stack 9 is assembled.

The fuel cell composite member of the present embodiment and the manufacturing method therefor and the fuel cell composite member of the first embodiment and the manufacturing method therefore have the same action and effect regarding parts having a common configuration. As in the present embodiment, MEGA 6 may be attached to the first separator 2 after the gasket 5 is integrally molded with the first separator 2.

### Others

Hitherto, the embodiments of the fuel cell composite member of the disclosure and the manufacturing method therefor have been described. However, the embodiments are not particularly limited to the above-described aspects. It is also possible to perform a variety of modified aspects and improved aspects that can be performed by persons skilled in the art.

The shape, position, size, and disposition number (hereinafter, abbreviated as “shape and the like”) of the side protrusion parts 401U (the penetrating side protrusion parts 402U and the non-penetrating side protrusion parts 403U) are not particularly limited. As shown in FIG. 11, the bottom surface of the side protrusion part 401U may be disposed at a position shallower than the groove bottom surface of the front-side groove part 400U. In addition, the bottom surface of the side protrusion part 401U may be disposed flush with the groove bottom surface of the front-side groove part 400U. As shown in FIG. 10, in a plan view, the shape of the side protrusion part 401U may be a tapered shape. In addition, in a plan view, the shape of the side protrusion part 401U may be a trapezoidal shape, a rectangular shape, an arc shape, or the like. The shapes of the plurality of side protrusion parts 401U may or may not match. As shown in FIG. 5, the side protrusion part 401U may be disposed in the front side outer frame part 404U. In addition, the side protrusion parts 401U may be disposed in the front-side interposition parts 405ULa, 405ULc, 405URa, and 405URc. As shown in FIG. 5, the side protrusion parts 401U may be caused to protrude outward from the front side outer frame part 404U in the surface direction. In addition, the side protrusion parts 401U may be caused to protrude inward from the front side outer frame part 404U in the surface direction.

The shape and the like of the continuous part inner penetrating hole 402Ua in the penetrating side protrusion part 402U are not particularly limited. The shape and the like of the continuous part inner non-penetrating hole 403Ua in the non-penetrating side protrusion parts 403U are not particularly limited. The non-penetrating side protrusion parts 403U may be disposed at parts other than the branch parts (the outer circumferential branch parts A3a and the inner circumferential branch parts A3b). The continuous part inner penetrating holes 402Ua and the continuous part inner non-penetrating holes 403Ua may not be disposed in the side protrusion parts 401U. The side protrusion parts 401U may not be disposed in the front-side disposition part 4U. The shapes and the like of the continuous part 40U and the independent part 41U are not particularly limited. For example, on the upper surface 2U, the two independent parts 41U may be disposed on both outer sides in the right and left direction (on both outer sides in the surface direction) of the continuous part 40U. In addition, the two independent parts 41U may be disposed at positions including the front and rear-direction central part (axis AX) of the upper surface 2U. On the upper surface 2U, the independent parts 41U need to be independent from the continuous part 40U.

The position of the continuous part 40U relative to the gate 800 in the disposition step is not particularly limited. For example, the penetrating side protrusion parts 402U (including the penetrating side protrusion parts 402U other than the X-direction outer-end-side protrusion part 402UX) may be caused to face the gate 800. In this case, as shown in FIG. 23, the continuous part inner penetrating holes 402Ua may be caused to face the gate 800. In addition, the continuous part inner penetrating holes 402Ua may not be caused to face the gate 800. The magnitude relationship between the outlet (downstream end) of the gate 800 and the inlet (upstream end) of the continuous part inner penetrating hole 402Ua is not particularly limited.

The outlet of the gate 800 may have a larger diameter or a smaller diameter than the inlet of the continuous part inner penetrating hole 402Ua. Alternatively, the outlet and the inlet may have the same diameter. In addition, parts other than the penetrating side protrusion parts 402U (the front side outer frame part 404U, the front-side interposition parts 405ULa, 405ULc, 405URa, and 405URc, the non-penetrating side protrusion parts 403U, and the like) may be caused to face the gate 800. In this case, the continuous part inner penetrating holes 402Ua or the continuous part inner non-penetrating holes 403Ua disposed in these parts may be caused to face the gate 800. In addition, a plurality of the gates 800 may be disposed in the mold 8.

The disposition direction of the stack 9 shown in FIG. 1 is not particularly limited. The lamination direction of the fuel cell composite member 1 and the second separator 7 may be vertically reversed relative to FIG. 1. It is needless to say that the lamination direction may be the horizontal direction, the vertical direction, and an inclined direction with respect to the horizontal direction. The shapes of the first separator 2 and the second separator 7 are not particularly limited. In a plan view, the shapes may be a rectangular shape, a square shape, or the like.

The materials of the first separator 2 and the second separator 7 are not particularly limited. The materials may be a resin, a metal, or the like that is conductive but is not corrosive. Examples thereof include stainless steel, titanium, copper, magnesium, aluminum, carbon, graphite, ceramics, a conductive resin (a thermoplastic or thermosetting resin containing carbon, graphite, a polyacrylonitrile-based carbon fiber, or the like), and the like.

The material of the gasket 5 is not particularly limited. The material may be an insulating elastomer having rubber elasticity. The material is preferably fluid in the raw material stage. The gasket 5 may contain, aside from the rubber component, a cross-linking agent, a co-cross-linking agent, a processing aid, a softener, a reinforcing material, or the like. Examples of a suitable rubber component include, aside from VMQ (silicone rubber), silicone rubber other than VMQ (PVMQ (methyl phenyl vinyl silicone rubber), FVMQ (fluorovinylmethylsiloxane rubber), and the like), EPDM (ethylene propylene diene monomer rubber), FKM (fluoroelastomer), and the like. In the case of using liquid-form silicone rubber as the raw material, the kind of the liquid-form silicone rubber is not particularly limited. The liquid-form silicone rubber may be a one-liquid type or a two-liquid type. In addition, the liquid-form silicone rubber may be a room-temperature-curing type or a heat-curing type.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A fuel cell composite member comprising:
a plate-like member having a gasket disposition part; and
a gasket that is integrally molded with the gasket disposition part,
wherein the gasket disposition part has a front-side disposition part that is disposed on a front surface of the plate-like member and a rear-side disposition part that is disposed on a rear surface of the plate-like member,
the front-side disposition part has a continuous part that is provided to be recessed on the front surface and disposed around a desired sealing target region and an independent part that is provided to be recessed on the front surface, independent from the continuous part, and disposed on an outer side of the continuous part in a surface direction,
the continuous part has a continuous part inner penetrating hole that penetrates the plate-like member in a front and rear direction and continues to the rear-side disposition part, the independent part has an independent part inner penetrating hole that penetrates the plate-like member in the front and rear direction and continues to the rear-side disposition part,
the continuous part and the independent part communicate with each other through the continuous part inner penetrating hole, the rear-side disposition part, and the independent part inner penetrating hole, and
in the independent part, the gasket is disposed so as not to protrude forward from the front

2. The fuel cell composite member according to claim 1,
wherein the continuous part has a front-side groove part in which a sealing lip of the gasket protrudes forward from the front surface and a plurality of side protrusion parts that protrudes outward in a groove width direction from the front-side groove part, and surface.
the plurality of side protrusion parts has a plurality of penetrating side protrusion parts having the continuous part inner penetrating hole and a plurality of non-penetrating side protrusion parts having a continuous part inner non-penetrating hole that does not penetrate the plate-like member in the front and rear direction.

3. The fuel cell composite member according to claim 2,
wherein the front surface exhibits a rectangular shape in a plan view,
among surface directions of the front surface, a longitudinal direction is designated as an X direction, a widthwise direction is designated as a Y direction,
the front-side groove part has a plurality of X-direction extension parts that extends in the X direction and a plurality of Y-direction extension parts that extends in the Y direction,
the independent part includes an X-direction central part of the front surface, two independent parts are disposed on both outer sides of the plurality of X-direction extension parts in the Y direction, and
among the plurality of penetrating side protrusion parts, two penetrating side protrusion parts include a Y-direction central part of the front surface and are X-direction outer-end-side protrusion parts that are disposed on both outer sides of the plurality of Y-direction extension parts in the X direction.

4. The fuel cell composite member according to claim 3,
wherein, among the plurality of penetrating side protrusion parts, two penetrating side protrusion parts include the X-direction central part of the front surface and are Y-direction outer-end-side protrusion parts that are disposed on both outer sides of the plurality of X-direction extension parts in the Y direction.

5. The fuel cell composite member according to claim 4,
wherein the continuous part has a branching and merging section that connects the X-direction outer-end-side protrusion part and the Y-direction outer-end-side protrusion part.
in the branching and merging section, a direction toward the X-direction outer-end-side protrusion part is designated as an upstream side, a direction toward the Y-direction outer-end-side protrusion part is designated as a downstream side,
the branching and merging section has an upstream trunk part that continues to the X-direction outer-end-side protrusion part, a downstream trunk part that is disposed downstream of the upstream trunk part and continues to the Y-direction outer-end-side protrusion part, a plurality of branch parts that is disposed between the upstream trunk part and the downstream trunk part, a branching part that connects a downstream end of the upstream trunk part and upstream ends of the plurality of branch parts, and a merging part that connects downstream ends of the plurality of branch parts and an upstream end of the downstream trunk part,
among the plurality of penetrating side protrusion parts, at least one of the penetrating side protrusion parts is a merging-part side protrusion part that is disposed in the merging part, and, among the plurality of non-penetrating side protrusion parts, at least one of the non-penetrating side protrusion parts is a branch-part side protrusion part that is disposed in an arbitrary branch part among the plurality of branch parts.

6. The fuel cell composite member according to claim 2,
wherein the penetrating side protrusion part exhibits a tapered shape having the continuous part inner penetrating hole at a groove-width-direction outer end, and the non-penetrating side protrusion part exhibits a tapered shape having the continuous part inner non-penetrating hole at a groove-width-direction outer end.

7. The fuel cell composite member according to claim 2,
wherein the continuous part further has a front-side interposition part that is interposed between a plurality of front-side groove parts of the front-side groove parts adjacent to each other in the surface direction, and
the front-side interposition part has the continuous part inner penetrating hole and the continuous part inner non-penetrating hole.

8. The fuel cell composite member according to claim 7,
wherein the rear-side disposition part has: a rear-side groove part that is provided to be recessed on the rear surface and from which a sealing lip of the gasket protrudes rearward from the rear surface; a groove edge part that is disposed flush with the rear surface and stretches from the rear-side groove part outward in the surface direction; and a rear-side interposition part that is provided to be recessed on the rear surface and is interposed between a plurality of rear-side groove parts of the rear-side groove parts adjacent to each other in the surface direction and in which the continuous part inner penetrating hole in the front-side interposition part is opened.

9. The fuel cell composite member according to claim 1, further comprising:
a membrane electrode assembly that is disposed on the rear surface of the plate-like member and has an electrolyte film and a pair of catalyst layers that are disposed on both front and rear surfaces of the electrolyte film,
wherein the gasket is integrally molded with the plate-like member and the membrane electrode assembly.

10. A method for manufacturing the fuel cell composite member according to claim 1, the method comprising:
a disposition step of disposing the plate-like member in a cavity of a mold so that a gate of the mold faces the continuous part; and
a raw material injection step of injecting a raw material of the gasket into the cavity from the gate, causing the raw material to flow into the continuous part, causing the raw material to flow from the continuous part to the rear-side disposition part through the continuous part inner penetrating hole, and causing the raw material to flow from the rear-side disposition part to the independent part through the independent part inner penetrating hole.

11. The method for manufacturing the fuel cell composite member according to claim 10,
wherein the continuous part has a front-side groove part in which a sealing lip of the gasket protrudes forward from the front surface and a plurality of side protrusion parts that protrudes outward in a groove width direction from the front-side groove part, and
the plurality of side protrusion parts has a plurality of penetrating side protrusion parts having the continuous part inner penetrating hole and a plurality of non-penetrating side protrusion parts having a continuous part inner non-penetrating hole that does not penetrate the plate-like member in the front and rear direction.

12. The method for manufacturing the fuel cell composite member according to claim 11,
wherein the front surface exhibits a rectangular shape in a plan view,
among surface directions of the front surface, a longitudinal direction is designated as an X direction, a widthwise direction is designated as a Y direction,
the front-side groove part has a plurality of X-direction extension parts that extends in the X direction and a plurality of Y-direction extension parts that extends in the Y direction,
the independent part includes an X-direction central part of the front surface, two independent parts are disposed on both outer sides of the plurality of X-direction extension parts in the Y direction,
among the plurality of penetrating side protrusion parts, two penetrating side protrusion parts include a Y-direction central part of the front surface and are X-direction outer-end-side protrusion parts that are disposed on both outer sides of the plurality of Y-direction extension parts in the X direction, and
in the disposition step, the plate-like member is disposed in the cavity so that the gate faces the X-direction outer-end-side protrusion parts.

13. The method for manufacturing the fuel cell composite member according to claim 12,
wherein, among the plurality of penetrating side protrusion parts, two penetrating side protrusion parts include the X-direction central part of the front surface and are Y-direction outer-end-side protrusion parts that are disposed on both outer sides of the plurality of X-direction extension parts in the Y direction.

14. The method for manufacturing the fuel cell composite member according to claim 13,
wherein the continuous part has a branching and merging section that connects the X-direction outer-end-side protrusion part and the Y-direction outer-end-side protrusion part,
in the branching and merging section, a direction toward the X-direction outer-end-side protrusion part is designated as an upstream side, a direction toward the Y-direction outer-end-side protrusion part is designated as a downstream side,
the branching and merging section has an upstream trunk part that continues to the X-direction outer-end-side protrusion part, a downstream trunk part that is disposed downstream of the upstream trunk part and continues to the Y-direction outer-end-side protrusion part, a plurality of branch parts that is disposed between the upstream trunk part and the downstream trunk part, a branching part that connects a downstream end of the upstream trunk part and upstream ends of the plurality of branch parts, and a merging part that connects downstream ends of the plurality of branch parts and an upstream end of the downstream trunk part,
among the plurality of penetrating side protrusion parts, at least one of the penetrating side protrusion parts is a merging-part side protrusion part that is disposed in the merging part, and
among the plurality of non-penetrating side protrusion parts, at least one of the non-penetrating side protrusion parts is a branch-part side protrusion part that is disposed in an arbitrary branch part among the plurality of branch parts.

15. The method for manufacturing the fuel cell composite member according to claim 11.
wherein the penetrating side protrusion part exhibits a tapered shape having the continuous part inner penetrating hole at a groove-width-direction outer end, and the non-penetrating side protrusion part exhibits a tapered shape having the continuous part inner non-penetrating hole at a groove-width-direction outer end.

16. The method for manufacturing the fuel cell composite member according to claim 11.
wherein the continuous part further has a front-side interposition part that is interposed between a plurality of front-side groove parts adjacent of the front-side groove parts adjacent to each other in the surface direction, and
the front-side interposition part has the continuous part inner penetrating hole and the continuous part inner non-penetrating hole.

17. The method for manufacturing the fuel cell composite member according to claim 16,
wherein the rear-side disposition part has: a rear-side groove part that is provided to be recessed on the rear surface and from which a sealing lip of the gasket protrudes rearward from the rear surface; a groove edge part that is disposed flush with the rear surface and stretches from the rear-side groove part outward in the surface direction; and a rear-side interposition part that is provided to be recessed on the rear surface and is interposed between a plurality of rear-side groove parts of the rear-side groove parts adjacent to each other in the surface direction and in which the continuous part inner penetrating hole in the front-side interposition part is opened.

18. The method for manufacturing the fuel cell composite member according to claim 10,
wherein a membrane electrode assembly that is disposed on the rear surface of the plate-like member and has an electrolyte film and a pair of catalyst layers that are disposed on both front and rear surfaces of the electrolyte film is further provided, and
in the disposition step, the membrane electrode assembly is disposed in the cavity together with the plate-like member, thereby integrally molding the gasket with the plate-like member and the membrane electrode assembly.
